(19) United States
(12) Patent Application Publication
(10) Pub. No.: US 2025/0056129 A1
(43) Pub. Date: Feb. 13, 2025

(54) INFORMATION PROCESSING DEVICE, INFORMATION PROCESSING SYSTEM, INFORMATION PROCESSING METHOD, AND PROGRAM

(71) Applicant: SONY GROUP CORPORATION, TOKYO (JP)

(72) Inventors: MAHO HAYASHI, TOKYO (JP); TETSUO IKEDA, TOKYO (JP); YUYA TAKAYAMA, TOKYO (JP)

(21) Appl. No.: 18/687,330

(22) PCT Filed: Mar. 10, 2022
(86) PCT No.: PCT/JP2022/010480

§ 371 Date: Feb. 28, 2024

(30) Foreign Application Priority Data
Sep. 15, 2021 (JP) 2021-150290

(51) Int. Cl. H04N 23/74; G06F 3/01; H04N 23/11; H04N 23/611

(52) U.S. Cl. CPC H04N 23/74; H04N 23/11; H04N 23/611; G06F 3/011

(57) ABSTRACT

The present technology relates to an information processing device, an information processing system, an information processing method, and a program that allow a user to comfortably perform an operation in a technology for recognizing a user operation on the basis of sensed spatial information. Environmental information for recognizing an environment of an operation space in which a user performs an operation on an image displayed in a vehicle cabin is acquired, recognition of the operation of the user is performed on the basis of first spatial information on the operation space sensed using first light or second spatial information on the operation space sensed using second light having a wavelength band different from a wavelength band of the first light, and spatial information to be used for the recognition is determined from among the first spatial information and the second spatial information on the basis of the environmental information.

### TECHNICAL FIELD

The present technology relates to an information processing device, an information processing system, an information processing method, and a program and more particularly, to an information processing device, an information processing system, an information processing method, and a program configured to allow a user to comfortably perform an operation in a technology for recognizing a user operation on the basis of sensed spatial information.

### BACKGROUND ART

Patent Document 1 discloses a technology of detecting an object around by selectively using visible light and near-infrared light according to brightness around.

### CITATION LIST

### Patent Document

Patent Document 1: Japanese Patent Application Laid-Open No. 2007-158820

### SUMMARY OF THE INVENTION

### Problems to be Solved by the Invention

In a technology for sensing spatial information and recognizing a user operation from a position, a shape, a motion, and the like of a predetermined part such as a hand of a user, there has been a case where the user is not allowed to comfortably perform an operation.

The present technology has been made in view of such circumstances and allows a user to comfortably perform an operation in a technology of recognizing a user operation on the basis of sensed spatial information.

### Solutions to Problems

An information processing device or a program according to a first aspect of the present technology is an information processing device including: an environmental information acquisition unit that acquires environmental information for recognizing an environment of an operation space in which a user performs an operation on an image displayed in a vehicle cabin; an operation recognition unit that performs recognition of the operation of the user on the basis of first spatial information on the operation space sensed using first light or second spatial information on the operation space sensed using second light having a wavelength band different from a wavelength band of the first light; and a determination unit that determines spatial information to be used for the recognition by the operation recognition unit from among the first spatial information and the second spatial information on the basis of the environmental information acquired by the environmental information acquisition unit, or a program for causing a computer to function as such an information processing device.

An information processing method according to the first aspect of the present technology is an information processing method including: by an environmental information acquisition unit of an information processing device including: the environmental information acquisition unit; an operation recognition unit; and a determination unit, acquiring environmental information for recognizing an environment of an operation space in which a user performs an operation on an image displayed in a vehicle cabin; by the operation recognition unit, performing recognition of the operation of the user on the basis of first spatial information on the operation space sensed using first light or second spatial information on the operation space sensed using second light having a wavelength band different from a wavelength band of the first light; and by the determination unit, determining spatial information to be used for the recognition by the operation recognition unit from among the first spatial information and the second spatial information on the basis of the environmental information acquired by the environmental information acquisition unit.

In the information processing device, the information processing method, and the program according to the first aspect of the present technology, environmental information for recognizing an environment of an operation space in which a user performs an operation on an image displayed in a vehicle cabin is acquired, recognition of the operation of the user is performed on the basis of first spatial information on the operation space sensed using first light or second spatial information on the operation space sensed using second light having a wavelength band different from a wavelength band of the first light, and spatial information to be used for the recognition is determined from among the first spatial information and the second spatial information on the basis of the environmental information.

An information processing system according to a second aspect of the present technology is an information processing system including: a display unit that displays an image in a vehicle cabin; an environmental information acquisition unit that acquires environmental information for recognizing an environment of an operation space in which a user performs an operation on the display unit; an imaging unit that performs sensing of spatial information on the operation space, using first light or second light; an operation recognition unit that performs recognition of the operation of the user on the basis of the spatial information sensed by the imaging unit; and a determination unit that determines light to be used for the sensing by the imaging unit from among the first light and the second light on the basis of the environmental information acquired by the environmental information acquisition unit.

In the information processing system according to the second aspect of the present technology, an image is displayed in a vehicle cabin, environmental information for recognizing an environment of an operation space in which a user performs an operation is acquired, sensing of spatial information on the operation space is performed using first light or second light, recognition of the operation of the user is performed on the basis of the sensed spatial information, and light to be used for the sensing is determined from among the first light and the second light on the basis of the environmental information.

### BRIEF DESCRIPTION OF DRAWINGS

FIG. 1 is a block diagram illustrating a configuration example of an information processing system according to a first embodiment to which the present technology is applied.

FIG. 2 is a block diagram illustrating a configuration example of the information processing system of the first embodiment.

FIG. 3 is a diagram exemplifying information contents of product characteristics.

FIG. 4 is a schematic diagram illustrating a configuration example of an imaging device in FIG. 2.

FIG. 5 is a diagram exemplifying information contents of environmental information.

FIG. 6 is a flowchart exemplifying an outline of a procedure of processing performed by the information processing system.

FIG. 7 is a diagram explaining, for each type of sensing method, spatial information obtained by sensing, an operation recognition method in a case where an operation method is a touch operation, and features.

FIG. 8 is a diagram explaining applicable types of operation methods for each type of sensing method and operation recognition methods corresponding to touch operations.

FIG. 9 is a flowchart exemplifying a processing procedure of optimization of the sensing method performed by the information processing system of the first embodiment.

FIG. 10 is a diagram exemplifying tables that are data of optimization rules referred to in the flowchart in FIG. 9.

FIG. 11 is a diagram representing relationships between types of content displayed on a display and predicted time.

FIG. 12 is a flowchart exemplifying a processing procedure of optimization of the sensing method based on prediction of an operating environment.

FIG. 13 is a diagram exemplifying information acquired or determined (predicted) in a processing procedure of optimization of the sensing method based on prediction of the operating environment.

FIG. 14 is a flowchart exemplifying a final processing procedure in optimization of the sensing method based on prediction of the operating environment.

FIG. 15 is a diagram explaining an example of a notification at the time of changing the operation method.

FIG. 16 is a block diagram illustrating a configuration example of an information processing system according to a second embodiment.

FIG. 17 is a flowchart exemplifying a schematic procedure of processing performed by the information processing system of the second embodiment.

FIG. 18 is a diagram explaining a rule of optimization when the information processing system of the second embodiment optimizes the operation method.

FIG. 19 is a diagram explaining operation methods relating to a decision operation in the information processing system of the second embodiment.

FIG. 20 is a diagram explaining operation methods relating to a selection operation in the information processing system of the second embodiment.

FIG. 21 is a flowchart exemplifying a processing procedure of optimization of the operation method performed by the information processing system of the second embodiment.

FIG. 22 is a diagram exemplifying data regarding rules of optimization used for optimization of the operation method by the information processing system of the second embodiment.

FIG. 23 is a diagram explaining a rule of optimization when an information processing system of a third embodiment optimizes the operation method so as to achieve a user operation optimal for the operating environment.

FIG. 24 is a diagram explaining an operation method optimized by the information processing system of the third embodiment.

FIG. 25 is a flowchart exemplifying a processing procedure of optimization of the operation method performed by the information processing system of the third embodiment.

FIG. 26 is a diagram explaining a rule of optimization when an information processing system of a fourth embodiment optimizes the operation method so as to achieve a user operation optimal for the operating environment.

FIG. 27 is a diagram explaining an operation method optimized by the information processing system of the fourth embodiment.

FIG. 28 is a flowchart exemplifying a processing procedure of optimization of the operation method performed by the information processing system of the fourth embodiment.

FIG. 29 is a flowchart exemplifying a processing procedure of optimization of the sensing method performed by an information processing system of a fifth embodiment.

FIG. 30 depicts blocks illustrating another configuration example of the imaging device in FIG. 2 (or FIG. 16).

FIG. 31 is a block diagram illustrating a configuration example of hardware of a computer in a case where the computer executes a series of processing tasks with a program.

### MODE FOR CARRYING OUT THE INVENTION

Hereinafter, embodiments of the present technology will be described with reference to the drawings.

<Information Processing System to which Present Technology Is Applied>

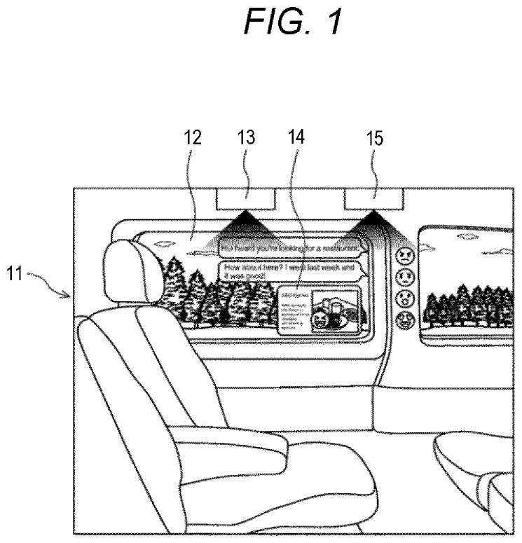

FIG. 1 is a diagram illustrating an example of use of an information processing system to which the present technology is applied in an automobile. A vehicle cabin 11 in FIG. 1 represents a part of the inside (interior) of an automobile vehicle in a simplified manner. A window glass 12 represents a glass portion such as a door glass installed on a door through which a user enters the inside of and exits to the outside of the vehicle cabin 11. A video presentation device 13 is installed in the vehicle cabin 11. The video presentation device 13 is a device that presents (displays) a video (image) to the user. In the description of the present technology, the video presentation device 13 is assumed to be a projector device that projects a video on the window glass 12. However, the video presentation device 13 may be any type of device as long as the device presents a video to the user. For example, the video presentation device 13 may be a device that displays a video on a transparent display, an opaque display, or the like installed on the window glass 12. The portion on which a video is displayed may be any portion such as a ceiling, a seat, an armrest, or a table of the vehicle cabin 11, as well as the window glass 12. Note that, in the projector device that projects a video, the portion on which a video is projected, that is, the portion on which a video is presented (displayed) to the user will be referred to as a display. A display 14 in FIG. 1 represents a portion on which a video is projected (a screen on which a video is displayed) by the video presentation device 13 that is a projector device. The video displayed on the display 14 may be a video including any type of content using characters, symbols, figures, still images, moving images, and the like.

A sensor 15 senses spatial information on an observation space, where a space including an operation space in which an operation of the user (user operation) is performed in the vehicle cabin 11 is assumed as the observation space. In the following description, a case where a user operation is performed on the display 14 is supposed, and the observation space is a space surrounding the display 14. However, the user operation is not limited to the case where the user operation is performed on the display 14. The spatial information (also referred to as sensor information) acquired by the sensor 15 is supplied to a processing unit 54 to be described later in the information processing system to which the present technology is applied. The processing unit 54 recognizes a state such as a position, a shape, and a motion of a predetermined part (a hand in the present embodiment) of the human body of the user on the basis of the spatial information from the sensor 15 and recognizes a user operation (operation content). The user operation represents a touch operation (contact operation), a gesture operation (such as a finger-pointing operation), a hover operation (non-contact operation), or the like performed on the display 14.

The user operation is an operation to give a predetermined instruction (input) to an application (software) that provides content displayed as a video (output image) on the display 14. The application that provides content may be an application that accepts a user operation as the following operations. For example, the application that provides content may be an application that accepts a user operation as an operation relating to the content displayed on the display 14. The application in this case may be regarded as an application that accepts a user operation as an operation relating to equipment that provides content. The application that provides content may be an application that accepts a user operation as an operation relating to equipment such as an air conditioner, an audio system, or a car navigation system provided in the host vehicle. The content provided by the application in this case may be, for example, content that designates operation positions for each kind of operation content by an image of a graphical user interface (GUI) of an operation button, or the like. That is, the application that provides content displayed on the display 14 is an application that accepts a user operation according to the content as an operation relating to equipment (application) that provides the content by itself or predetermined equipment other than that equipment.

In the following, a user operation to give a predetermined instruction (input) to an application that provides content will be referred to as a user operation on equipment or simply a user operation. In the description of the present technology, the user operation on equipment is assumed to be performed by a touch operation or the like on the display 14, but is not limited to the case where the user operation is performed on the display 14. The application that accepts a user operation is not necessarily limited to the application that provides content displayed on the display 14.

Note that, for all the embodiments of the information processing system to be described below, a case where the information processing system is used in an automobile similarly to FIG. 1 is supposed. However, the information processing system to which the present technology is applied can be applied as a technology for sensing spatial information on an operation space and recognizing a user operation in an interior (vehicle cabin) of any transportation device, as well as an automobile, or an interior in which a surrounding environment such as brightness fluctuates.

### Information Processing System of First Embodiment

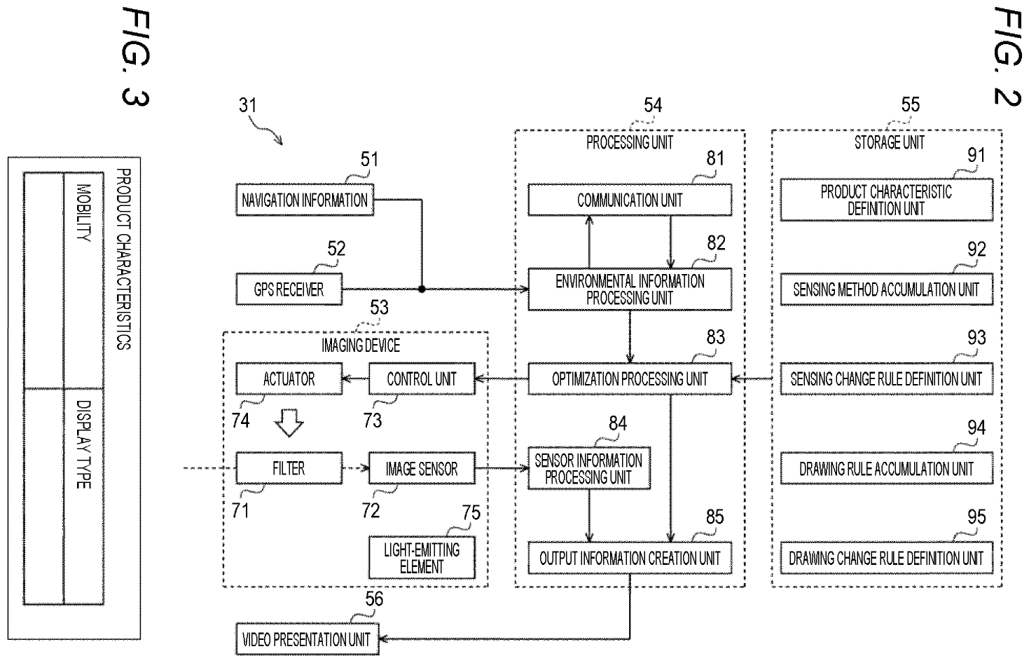

FIG. 2 is a block diagram illustrating a configuration example of an information processing system of a first embodiment to which the present technology is applied. In FIG. 2, an information processing system 31 of the first embodiment includes a navigation information 51, a global positioning system (GPS) receiver 52, an imaging device 53, a processing unit 54, a storage unit 55, and a video presentation unit 56.

The navigation information 51 is information obtained from a general car navigation system mounted on the host vehicle. For example, the navigation information 51 includes information such as a current location, a destination, a moving route, a traveling direction, and a surrounding map of the current location. The navigation information 51 is supplied to the processing unit 54.

The GPS receiver 52 receives a radio wave from a satellite in a general satellite positioning system and measures the current location or the like of its own vehicle (host vehicle) on the basis of the received radio wave. GPS information including the measured current location of the host vehicle, and the like is supplied to the processing unit 54. Note that the GPS information from the GPS receiver 52 is also supplied to the car navigation system and is also reflected in the navigation information 51.

The imaging device 53 functions as the sensor 15 in FIG. 1. The imaging device 53 senses (measures) spatial information on the observation space (mainly, spatial information on an operation space). The imaging device 53 can switch and acquire a color image (red-green-blue (RGB) image) and a depth image (range image) as a result of sensing the spatial information on the observation space. In the depth image, a pixel value of each pixel represents a distance to a subject (object point) corresponding to each pixel. The color image or the depth image acquired by the imaging device 53 is supplied to the processing unit 54 as spatial information (also referred to as sensor information). Note that, in one case, the imaging device 53 may acquire a grayscale black-and-white image instead of the color image. Assuming that an image in which a pixel value of each pixel represents luminance of the subject is distinguished from the depth image and referred to as a captured image, the imaging device 53 can switch and acquire the captured image and the depth image, and the captured image may be either a color image or a black-and-white image.

The processing unit 54 creates a video (output image) of content to be presented to the user by the application (software) being executed. The application may be executed in the processing unit 54 in one case or may be executed in a processing unit different from the processing unit 54 in another case. The video created by the processing unit 54 is supplied to the video presentation unit 56. The processing unit 54 recognizes a user operation on the basis of the sensor information from the imaging device 53 and supplies the recognized user operation to the application. However, in one case, the user operation may be not only recognized on the basis of the sensor information from the imaging device 53 but also recognized on the basis of an input signal from an input device (not illustrated) such as a touch panel or a pointing device.

The processing unit 54 optimizes at least one of a sensing method to be applied to sensing of spatial information in the imaging device 53, an operation recognition method to be applied to recognition (recognition processing) of a user operation, or an operation method to be applied to a user operation, and a drawing method to be applied to drawing (drawing processing) of a video (output image) to be supplied to the video presentation unit 56, according to the environment of the operation space (hereinafter, referred to as an operating environment or simply an environment). Note that the sensing method to be applied to sensing of spatial information in the imaging device 53 will be also simply referred to as a sensing method. The operation recognition method to be applied to recognition of a user operation by the processing unit 54 will be also simply referred to as an operation recognition method. The operation method to be applied to a user operation will be also simply referred to as an operation method. The drawing method to be applied to drawing (drawing processing) of a video (output image) to be supplied to the video presentation unit 56 will be also simply referred to as a drawing method. Details of the sensing method, the operation recognition method, and the operation method will be described later. The drawing method will be appropriately described as necessary.

In the present embodiment, since the operation space is a space surrounding the display 14, the operating environment corresponds to an environment around the display 14. In recognition of the operating environment, for example, information regarding circumstances in which the operation space (display 14) is located, such as brightness (illuminance) and temperature (air temperature) in the operation space and around the operation space, a culture area (country, region, or the like) to which a place (position) where the operation space (host vehicle) exists belongs, and the presence or absence of a person around the outside of the host vehicle (around the operation space), is used. In order to obtain information for recognizing the operating environment (hereinafter, referred to as environmental information), the processing unit 54 acquires necessary information such as the navigation information 51, the GPS information from the GPS receiver 52, and meteorological information from the Internet or the like.

The storage unit 55 stores various sorts of data. The data stored in the storage unit 55 includes data referred to by the processing unit 54 when optimizing the sensing method, the operation recognition method, the operation method, or the drawing method. The storage unit 55 includes a product characteristic definition unit 91, a sensing method accumulation unit 92, a sensing change rule definition unit 93, a drawing rule accumulation unit 94, and a drawing change rule definition unit 95.

For example, as in FIG. 3, the product characteristic definition unit 91 stores data representing the presence or absence of mobility and the display type of the display 14. The display type represents the type of the display 14 to be used, such as a transparent or opaque display, for example.

The sensing method accumulation unit 92 stores data representing the type of sensing method applicable to sensing. Note that, if necessary, the sensing method accumulation unit 92 is assumed to also store data representing the type of operation recognition method applicable to operation recognition and data representing the type of operation method applicable to user operation. The sensing change rule definition unit 93 stores data regarding a rule of optimization (hereinafter, an optimization rule) when the sensing method is optimized (changed). Note that, if necessary, the sensing change rule definition unit 93 is assumed to also store data regarding an optimization rule when optimizing the operation recognition method and data relating to an optimization rule when optimizing the operation method.

The drawing rule accumulation unit 94 stores data representing the type of drawing method. The drawing change rule definition unit 95 stores data regarding an optimization rule when optimizing the drawing method.

The video presentation unit 56 displays the video (output image) supplied from the processing unit 54 on the display 14 in FIG. 1 to present the video to the user. The video presentation unit 56 may be any display device such as a projector device, a liquid crystal display, or an organic electro luminescence (EL) display. In the description of the present technology, the video presentation unit 56 is assumed to be a projector device.

### (Details of Imaging Device 53)

In FIG. 2, the imaging device 53 includes a filter 71, an image sensor 72, a control unit 73, an actuator 74, and a light-emitting element 75.

The filter 71 constitutes a part of an imaging optical system (not illustrated). The imaging optical system condenses light from the observation space (imaging range) and forms an optical image of a subject on a light-receiving surface of the image sensor 72. The filter 71 transmits, to the image sensor 72, only light in a wavelength band according to optical characteristics of the filter 71 among rays of light from the subject incident on the imaging optical system. As will be described later, the filter 71 is switched to a plurality of types of filters having different optical characteristics.

The image sensor 72 captures (photoelectrically converts) an image formed by the imaging optical system and converts the captured image into an image signal that is an electrical signal. The image sensor 72 can capture both of a color (RGB) image formed by visible light and an infrared image formed by infrared light.

The control unit 73 controls the filter 71 in accordance with an instruction from the processing unit 54. The control for the filter 71 is control to effectively arrange a filter to be applied as the filter 71 for the imaging optical system, among the plurality of types of filters having different optical characteristics. The control unit 73 supplies a drive signal to the actuator 74 to control the filter 71. The types of filters will be described later.

The actuator 74 activates a switching mechanism for a filter to be arranged effectively for the imaging optical system, among the plurality of types of filters having different optical characteristics. The actuator 74 is driven in accordance with the drive signal from the control unit 73.

The light-emitting element 75 emits infrared light toward the observation space. The infrared light generally represents light having a wavelength from a wavelength of about 780 nm or more in the near-infrared to a wavelength of about 1000 mm in the far-infrared, but in the present embodiment, the infrared light is assumed to be near-infrared light including a wavelength of about 850 nm and a wavelength of about 940 nm included in the near-infrared wavelength band. Note that the light emitted by the light-emitting element 75 is only required to be light in a wavelength band including the wavelength bands of all the infrared light filters applicable as the filter 71.

According to the imaging device 53, by switching the type of the filter to be applied as the filter 71 (hereinafter, referred to as the type of the filter 71), either the color image (RGB image) by visible light from the subject or the infrared image by infrared light from the subject is formed on the light-receiving surface of the image sensor 72.

For example, it is assumed that the type of the filter 71 is a filter (visible light filter) that transmits at least a wavelength band of visible light (wavelength band with a lower limit of about 360 to 400 nm and an upper bound of about 760 to 830 nm). Also a case where no filter is arranged as the filter 71 (a case without any filter) is assumed to correspond to the case where the type of the filter 71 is a visible light filter. In this case, the color image is formed on the light-receiving surface of the image sensor 72, and the color image is captured by the image sensor 72.

It is assumed that the type of the filter 71 is a filter (infrared light filter) that transmits only light in a partial wavelength band of the wavelength band of infrared light. In this case, the infrared image is formed on the light-receiving surface of the image sensor 72, and the infrared image is captured by the image sensor 72. In a case where the type of the filter 71 is an infrared light filter, the imaging device 53 discharges pulsed infrared light (infrared light pulse) from the light-emitting element 75. The infrared light pulse discharged from the light-emitting element 75 is reflected by the subject to form an infrared image on the light-receiving surface of the image sensor 72. In the image sensor 72, exposure (charge accumulation) is performed in synchronization with the timing at which the infrared light pulse is emitted from the light-emitting element 75. This generates the depth image (range image) based on the principle of time of flight (TOF), and the generated depth image is supplied to the processing unit 54. The depth image may be generated by the image sensor 72 in one case or may be generated by an arithmetic processing unit (not illustrated) or the processing unit 54 at a subsequent stage on the basis of the infrared image output by the image sensor 72 in another case. In the present embodiment, it is assumed that the depth image is generated at least in the imaging device 53 and supplied to the processing unit 54.

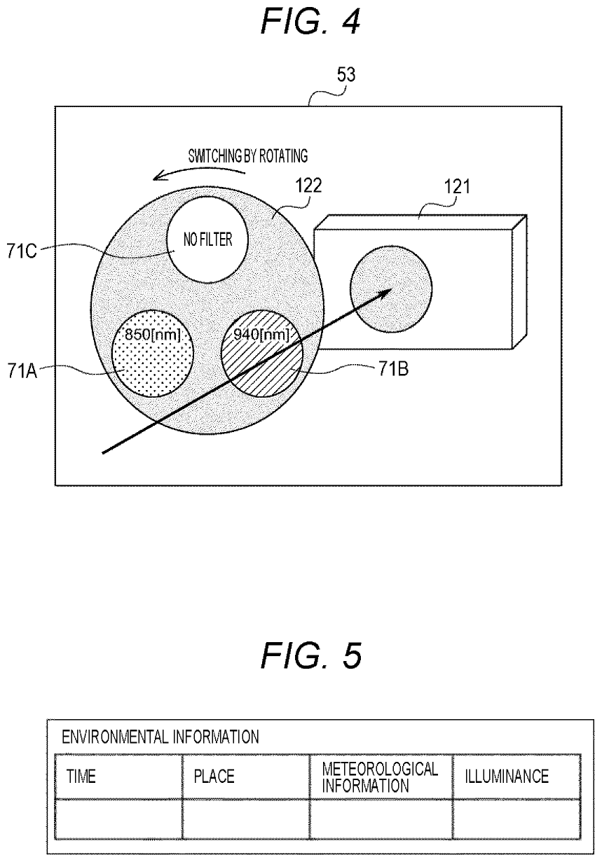

FIG. 4 is a schematic diagram illustrating a configuration example of the imaging device 53 in FIG. 2. In FIG. 4, a camera 121 includes the image sensor 72 in FIG. 2, an imaging optical system (not illustrated) (excluding the filter 71), and other peripheral circuits. The camera 121 captures a color image and an infrared image formed by the imaging optical system. A turret 122 holds filters 71A, 72B, and 71C that can be inserted into and detached from the imaging optical system as the filter 71 in FIG. 2. The turret 122 is rotationally driven by the actuator 74 in FIG. 2. As the turret 122 rotates, any one of the three filters 71A, 72B, and 71C is arranged in an insertable and detachable manner on an optical axis of the imaging optical system of the camera 121. Among the three filters 71A, 72B, and 71C, the filter 71A is an infrared light filter having a characteristic of transmitting light having a wavelength band with a center wavelength of about 850 nm (hereinafter, also referred to as an 850 nm filter 71A) (the bandwidth is, for example, on the order of 10 nm). The filter 71B is an infrared light filter having a characteristic of transmitting light having a wavelength band with a center wavelength of about 940 nm (hereinafter, also referred to as a 940 nm filter 71B) (the bandwidth is, for example, on the order of 10 nm). The filter 71C represents an opening (cavity) formed in the turret 122 and represents that there is no filter (no filter is arranged). However, the filter 71C may be a visible light filter that transmits a wavelength band of visible light (an infrared light-shielding filter that shields infrared light). The filter 71C is also referred to as a visible light filter 71C.

In the present embodiment, as in FIG. 4, it is assumed that the imaging device 53 can arrange any one of two infrared light filters (the 850 nm filter 71A and the 940 nm filter 71B) and a visible light filter (visible light filter 71C) having different wavelength bands to be transmitted, as the filter 71 in FIG. 2 in the capturing optical system. However, the number of types of the filter 71 may be two or four or more, and the wavelength band of light transmitted by the infrared light filter is also not limited to the case where the center wavelength is 850 nm or 940 nm. The wavelength band of light transmitted by the visible light filter 71C also may not be the entire wavelength band of visible light, and the visible light filter 71C may not be selectable as the type of the filter 71 in one case.

### (Details of Processing Unit 54)

In FIG. 2, the processing unit 54 includes a communication unit 81, an environmental information processing unit 82, an optimization processing unit 83, a sensor information processing unit 84, and an output information creation unit 85. Note that the processing unit 54 in FIG. 2 performs processing corresponding to a control layer of a general operating system (OS), such as drawing control of multi-content, including drawing of a window displaying content provided by an application, and event delivery for user operation or the like to an application. Both of a case where an application (software program) that provides content to the user is executed by the processing unit 54 and a case where the application is executed by a processing unit different from the processing unit 54 are acceptable, but description of the processing unit that executes the application will be omitted.

The communication unit 81 communicates with a site (external server device) connected to a communication network such as the Internet. For example, the communication unit 81 communicates with an external server device that provides meteorological information and acquires meteorological information (such as weather) at a predetermined place (position) such as the current location of the host vehicle and at a predetermined time such as the current time. The acquired meteorological information is supplied to the environmental information processing unit 82. The communication unit 81 acquires necessary information, as well as the meteorological information, as appropriate from the external server device by communication.

On the basis of the navigation information 51 and the GPS information from the GPS receiver 52, the environmental information processing unit 82 acquires, from the external server device via the communication unit 81, meteorological information at the current location at the current time, meteorological information at a predetermined place on the moving route at the scheduled time of passing through that place, and the like. The environmental information processing unit 82 supplies environmental information for recognizing the operating environment to the optimization processing unit 83 on the basis of the navigation information 51, the GPS information, and the meteorological information.

FIG. 5 is a diagram exemplifying information contents of the environmental information. As in FIG. 5, the environmental information includes information regarding a time, a place, meteorological information, and illuminance. For example, it is assumed that the environmental information processing unit 82 acquires weather corresponding to the current location specified by the GPS information or the like and the current time (date and time), as meteorological information from the external server device. In this case, the environmental information processing unit 82 supplies the current location, the current time, and the weather acquired from the external server device to the optimization processing unit 83 as the environmental information. For example, it is assumed that an illuminometer for measuring the illuminance of the operating environment is mounted on the host vehicle, and the environmental information processing unit 82 can acquire the illuminance measured by the mounted illuminometer. In that case, the environmental information processing unit 82 supplies, as the environmental information, the place and time at which the illuminance was measured and illuminance information measured by the illuminometer to the optimization processing unit 83 as the environmental information. In one case, the environmental information may include both or either of the meteorological information or the illuminance information. In a case where the environmental information processing unit 82 is not allowed to acquire the illuminance information, the illuminance information is not included in the environmental information. The information contents of the environmental information illustrated in FIG. 5 are an example and, the environmental information is not limited to these information contents. The environmental information includes any information for recognizing the operating environment.

The optimization processing unit 83 optimizes at least one of the sensing method, the operation recognition method, and the operation method, and the drawing method on the basis of the environmental information from the environmental information processing unit 82 and the data stored beforehand in the storage unit 55.

The optimization of the sensing method, the operation recognition method, the operation method, and the drawing method means that the sensing method, the operation recognition method, the user operation, and the drawing method are determined so as to achieve a user operation optimal (suitable) for the operating environment. The user operation optimal for the operating environment means a user operation that can be performed comfortably by the user regardless of the operating environment by suppressing disadvantages that can occur due to the operating environment, such as a decrease in sensing accuracy for the spatial information, an increase in erroneous recognition on the user operation, a decrease in operability of the user operation, or discomfort to other people due to the user operation (finger-pointing operation or the like). Note that the drawing method will be appropriately described as necessary.

The sensing method represents a method of sensing when the spatial information on the observation space (operation space) is sensed in the imaging device 53. Specifically, the sensing method is specified by the type of the filter 71. In the present embodiment, the sensing method can be selected from among three sensing methods in a case where the filter 71 is the 850 nm filter 71A, a case where the filter 71 is the 940 nm filter 71B, and a case where the filter 71 is the visible light filter 71C.

The sensing method in a case where the filter 71 is the 850 nm filter 71A or the 940 nm filter 71B includes a process until the depth image is acquired. The sensing method in a case where the filter 71 is the visible light filter 71C includes a process until the color image is acquired. Note that, for example, in a case where the filter 71 is the 850 nm filter 71A, a sensing method for the purpose of finally acquiring the depth image and a sensing method for the purpose of finally acquiring the infrared image are deemed as different types of sensing methods in a case where these sensing methods are selectable. Data regarding such applicable types of sensing methods is stored in the sensing method accumulation unit 92 of the storage unit 55 in FIG. 2. In a case where the optimization processing unit 83 optimizes the sensing method so as to achieve a user operation optimal for the operating environment, data regarding the optimization rule for that optimization is stored in the sensing change rule definition unit 93 of the storage unit 55 in FIG. 2. The optimization processing unit 83 optimizes the sensing method in accordance with the optimization rule indicated by the data of the sensing change rule definition unit 93 (determines an optimal sensing method to be applied to sensing of the spatial information). After optimizing the sensing method, the optimization processing unit 83 instructs the control unit 73 of the imaging device 53 to perform sensing with the optimized sensing method.

The operation recognition method represents a method of recognizing a user operation on the basis of the sensor information (the color image or the depth image) acquired from the imaging device 53. There is a plurality of types of selectable operation recognition methods. The operation recognition method can be specified by an algorithm (sensing algorithm) of processing for recognizing a user operation. Note that, in a case where the sensing algorithm is mentioned, it is assumed that the sensing algorithm also includes an algorithm of processing for sensing the spatial information in the imaging device 53, and in a case where the sensing algorithm is specified, it is assumed that both of the sensing method and the operation recognition method are specified.

The data regarding the types of operation recognition methods applicable to recognition of the user operation is stored in the sensing method accumulation unit 92 of the storage unit 55 in FIG. 2, together with the data regarding the types of sensing methods, for example. In a case where the optimization processing unit 83 optimizes the operation recognition method so as to achieve a user operation optimal for the operating environment, data regarding the optimization rule is stored in the sensing change rule definition unit 93 of the storage unit 55 in FIG. 2. The optimization processing unit 83 optimizes the operation recognition method in accordance with the optimization rule indicated by the data of the sensing change rule definition unit 93 (determines an optimal operation recognition method to be applied to recognition of the user operation). After optimizing the operation recognition method, the optimization processing unit 83 instructs the sensor information processing unit 84 to recognize the user operation by the optimized operation recognition method.

The operation method represents a method of operation performed by the user. As for the operation method, not only the roughly classified types such as the touch operation, the gesture operation, and the hover operation, but also subdivided operation methods in a case where these roughly classified types of operation methods are further subdivided are assumed as separate types of operation methods. For example, in the gesture operation, in a case where the gestures are different with regard to the operation for the same instruction, these gestures are deemed as separate types of operation methods.

The data regarding the types of operation methods applicable to user operation is stored in the sensing method accumulation unit 92 of the storage unit 55 in FIG. 2, together with the data regarding the types of sensing methods, for example. In a case where the optimization processing unit 83 optimizes the operation method so as to achieve a user operation optimal for the operating environment, data regarding the optimization rule is stored in the sensing change rule definition unit 93 of the storage unit 55 in FIG. 2. The optimization processing unit 83 optimizes the operation method in accordance with the optimization rule indicated by the data of the sensing change rule definition unit 93 (determines the optimal operation method to be applied to the user operation). Since the operation method is reflected in the operation recognition method, the optimization processing unit 83 instructs the sensor information processing unit 84 to recognize the user operation by the operation recognition method determined in correspondence with the optimized operation method.

The drawing method represents a method of drawing content to be displayed as a video (output image) on the display 14 by the video presentation unit 56. There is a plurality of types of drawing methods applicable to drawing. For example, visual effects including the brightness, color, arrangement and the like of content vary depending on the type of drawing method. Alternatively, the form of content (such as an operation button image) relating to a GUI that accepts a user operation varies depending on the type of drawing method. The form of the content relating to the GUI has a form suitable for each operation method such as the touch operation, the gesture operation, or the hover operation, for example, and varies depending on the type of drawing method. Data regarding these applicable types of drawing methods is stored in the drawing rule accumulation unit 94 of the storage unit 55 in FIG. 2. The data regarding the optimization rule when the optimization processing unit 83 optimizes the drawing method is stored in the drawing change rule definition unit 95 of the storage unit 55 in FIG. 2. The optimization processing unit 83 optimizes the drawing method in accordance with the optimization rule indicated by the data of the drawing change rule definition unit 95 (determines an optimal drawing method to be applied to drawing of the output image). After optimizing the drawing method, the optimization processing unit 83 instructs the output information creation unit 85 to draw output information (output image) by the optimized drawing method.

Here, the sensing method, the operation recognition method, and the operation method are not allowed to be determined to any method independently of each other and correlatively have a relationship in which changeable ranges (applicable types) are changed according to a change in the type of another method. For this reason, the following situation can occur. In a case where the sensing method, the operation recognition method, and the operation method are optimized so as to achieve a user operation optimal for the operating environment, for example, it is conceivable that the purposes are assumed to be suppression of a decrease in sensing accuracy for the spatial information (first purpose), suppression of an increase in erroneous recognition on the user operation (second purpose), and suppression of a decrease in operability (ease of operation, or the like) of the user operation (third purpose), where the decrease or increase can occur due to the operating environment (a fluctuation in the operating environment). Focusing only on the first purpose and the second purpose, in a case where the first purpose is prioritized over the second purpose, the sensing method is preferentially optimized to attain the first purpose, and the operation recognition method is optimized to attain the second purpose within applicable types with respect to the optimized sensing method. On the other hand, in a case where the second purpose is prioritized over the first purpose, the operation recognition method is preferentially optimized to attain the second purpose, and the sensing method is optimized to attain the first purpose within applicable types with respect to the optimized operation recognition method. At this time, the sensing method optimized in the former is sometimes different from the sensing method optimized in the latter. Similarly, the operation recognition method optimized in the former is sometimes different from the operation recognition method optimized in the latter.

Such a situation can also occur between the operation recognition method optimized to attain the second purpose and the operation method optimized to attain the third purpose and can also occur between the sensing method and the operation method with the operation recognition method interposed.

Meanwhile, the optimization processing unit 83 optimizes the sensing method, the operation recognition method, and the operation method in accordance with an optimization rule assigned beforehand (an optimization rule indicated by data stored in the sensing change rule definition unit 93 of the storage unit 55) on the basis of the operating environment (environmental information). That optimization rule is created in consideration of, for example, which purpose of a plurality of optimization purposes such as the first purpose to the third purpose is prioritized. However, in one case, possible combinations of the sensing method, the operation recognition method, and the operation method may be assigned, and one combination may be treated as one method. In that case, the sensing method, the operation recognition method, and the operation method are optimized as a whole.

In the present first embodiment and second to fifth embodiments to be described below, attention is focused on one environmental factor that can cause a disadvantage in the user operation among diverse environmental factors that have influence on (bring about a fluctuation in) the operating environment. The purpose to suppress a disadvantage arising from the focused environmental factor is assumed as the main purpose. The main purpose is assumed to be prioritized over the purposes to suppress other disadvantages. It is assumed that the optimization rule is assigned such that a method to be optimized to attain the main purpose among the sensing method, the operation recognition method, and the operation method is optimized preferentially over other methods.

Specifically, in the first embodiment, attention is focused on the amount of infrared light (a fluctuation in the amount of light) from the outside world to the operation space, as an environmental factor, and a disadvantage arising from the focused environmental factor is assumed to be a decrease in sensing accuracy for the spatial information. The optimization rule has a main purpose of suppressing that disadvantage and preferentially optimizes the sensing method in order to attain that main purpose.

In the second embodiment, attention is focused on the fact that there is a person (whether or not there is a person) around the operation space (around the host vehicle), as an environmental factor, and a disadvantage arising from the focused environmental factor is assumed to be giving discomfort to other people with a finger-pointing operation or the like. The optimization rule has a main purpose of suppressing that disadvantage and preferentially optimizes the operation method in order to attain that main purpose.

In the third embodiment, attention is focused on the fact that the air temperature is low (the air temperature fluctuates) in the operating environment, as an environmental factor, and disadvantages arising from the focused environmental factor are assumed that the visibility of the display 14 decreases due to touch operation and the hand of the user cools (the user is uncomfortable). The optimization rule has a main purpose of suppressing those disadvantages and preferentially optimizes the operation method in order to attain that main purpose.

In the fourth embodiment, attention is focused on that the sunlight comes (whether or not the sunlight comes) into the operation space, as an environmental factor, and disadvantages arising from the focused environmental factor are assumed that the user gets sunburned and the user gets hot. The optimization rule has a main purpose of suppressing those disadvantages and has been determined so as to preferentially optimize the operation method in order to attain that main purpose.

The fifth embodiment is similar to the first embodiment. However, in the fifth embodiment, an object to be considered when recognizing the amount of infrared light (a fluctuation in the amount of light) included in the outside world, which is the focused environmental factor, is different from the first embodiment.

As for other methods apart from the method to be preferentially optimized to attain the main purpose among the sensing method, the operation recognition method, and the operation method, the optimization rule is not necessarily assigned so as to be uniquely determined on the basis of the operating environment (environmental information). For example, it is assumed that applicable types (changeable range) of other methods are restricted with respect to the method preferentially optimized to attain the main purpose. In that case, other methods are sometimes optimized within the applicable types in order to attain a purpose arising from the operating environment or a purpose not arising from the operating environment. Alternatively, other methods are sometimes also determined within their applicable types according to a request from an application or the like. Other methods may be determined in any way in one case.

In the following description of the first to fifth embodiments, among the sensing method, the operation recognition method, and the operation method, only the optimization rule of the method to be preferentially optimized to attain the main purpose will be described. It is assumed that other methods are determined on the basis of any request (also including a request according to the optimization rule) in addition to a case where other methods are determined according to the optimization rule, and the detailed description will be appropriately omitted. The sensing method, the operation recognition method, or the operation method determined on the basis of any request as well as the optimization rule will be also referred to as an optimal sensing method, an optimal operation recognition method, or an optimal operation method, similarly to the case of optimization according to the optimization rule. In a case where the optimized sensing method, the optimized operation recognition method, or the optimized operation method is mentioned, it is assumed that the method has been determined in accordance with the optimization rule.

In FIG. 2, the sensor information processing unit 84 recognizes the user operation on the basis of the sensor information (spatial information) from the imaging device 53. In the recognition of the user operation based on the image signal, the sensor information processing unit 84 uses the operation recognition method instructed by the optimization processing unit 83. The recognized operation of the user is supplied to an application (not illustrated) and the output information creation unit 85.

The output information creation unit 85 creates an output image (video) for displaying content provided by the executed application on the display 14. In the creation (drawing) of the output image, the output information creation unit 85 uses the drawing method instructed from the optimization processing unit 83. The output information creation unit 85 creates an operation response image or the like that alters according to the user operation on the basis of the user operation recognized by the sensor information processing unit 84 and includes the created operation response image or the like in the output image. The output information creation unit 85 supplies the created output image to the video presentation unit 56 and causes the video presentation unit 56 to display the output image on the display 14.

### Outline of Processing Procedure of Information Processing System 31 of First Embodiment

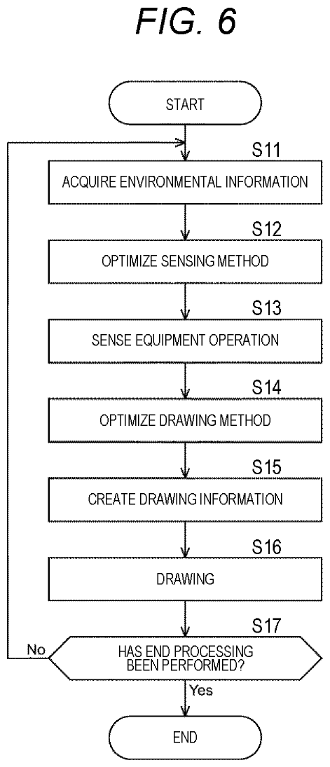

FIG. 6 is a flowchart exemplifying an outline of a procedure of processing performed by the information processing system 31. In step S11, the environmental information processing unit 82 acquires the navigation information 51, the GPS information from the GPS receiver 52, the meteorological information via the communication unit 81, and the like and acquires the environmental information for recognizing the operating environment. The processing proceeds from step S11 to step S12. In step S12, the optimization processing unit 83 optimizes the sensing method so as to achieve a user operation optimal for the operating environment on the basis of the environmental information acquired in step S11 and the optimization rule assigned beforehand. The optimization processing unit 83 determines an optimal operation recognition method and an optimal operation method within applicable types with respect to the optimized sensing method on the basis of any request. The processing proceeds from step S12 to step S13. Note that, since the operation method is automatically determined by determination of the optimal operation recognition method, there is also a case where the optimization processing unit 83 does not perform the processing of determining the operation method, for example, in a case where the optimal operation recognition method is determined ahead of the operation method.

In step S13, the imaging device 53 senses the spatial information by the sensing method optimized in step S12, and the sensor information processing unit 84 recognizes the user operation by the optimal operation recognition method determined in step S12 on the basis of the spatial information (sensor information) from the imaging device 53. The processing proceeds from step S13 to step S14. In step S14, the optimization processing unit 83 optimizes the drawing method for the output image to be displayed on the display 14 on the basis of the environmental information acquired in step S11 and the optimization rule assigned beforehand. The processing proceeds from step S14 to step S15.

In step S15, the output information creation unit 85 creates the output image to be displayed on the display 14 of the video presentation unit 56 by the drawing method optimized in step S14. The processing proceeds from step S15 to step S16. In step S16, the processing unit 54 verifies whether or not predetermined end processing has been performed. In a case of negation in step S16, the processing returns to step S11, and steps S11 to S16 are repeated. In a case of affirmation in step S16, the processing in this flowchart ends.

Optimization of the sensing method and determination of the optimal operation recognition method and operation method in step S12 in FIG. 6, and recognition of the user operation in step S13 will be described.

In the optimization of the sensing method, the optimization processing unit 83 optimizes the sensing method on the basis of the environmental information and the optimization rule assigned beforehand (the optimization rule indicated by the data of the sensing change rule definition unit 93 of the storage unit 55; hereinafter, will be omitted). Specifically, the type of the filter 71 of the imaging device 53 is determined to any of the filters 71A to 71C in FIG. 4. As a result, in the imaging device 53, the determined filter is arranged in the imaging optical system, and sensing of the spatial information by the imaging device 53 is performed by the optimized sensing method.

In the determination of the optimal operation recognition method and operation method, the optimization processing unit 83 determines the operation recognition method within applicable types with respect to the optimized sensing method on the basis of any request. Specifically, the optimization processing unit 83 may optimize the operation recognition method and the operation method on the basis of the environmental information and the optimization rule, or may determine the optimal operation recognition method and operation method on the basis of a request from other than the optimization rule. As a result, in the sensor information processing unit 84, the recognition of the user operation based on the spatial information (sensor information) from the imaging device 53 is performed by the optimal operation recognition method determined by the optimization processing unit 83.

When the sensing method has been optimized and the optimal operation recognition method and the optimal operation method have been determined, the user can perform a user operation on equipment, using the optimal operation method determined by the optimization processing unit 83. When roughly classified, the types of operation methods include the touch operation (contact operation), the gesture operation (such as a finger-pointing operation), the hover operation (non-contact operation), and the like performed on the display 14.

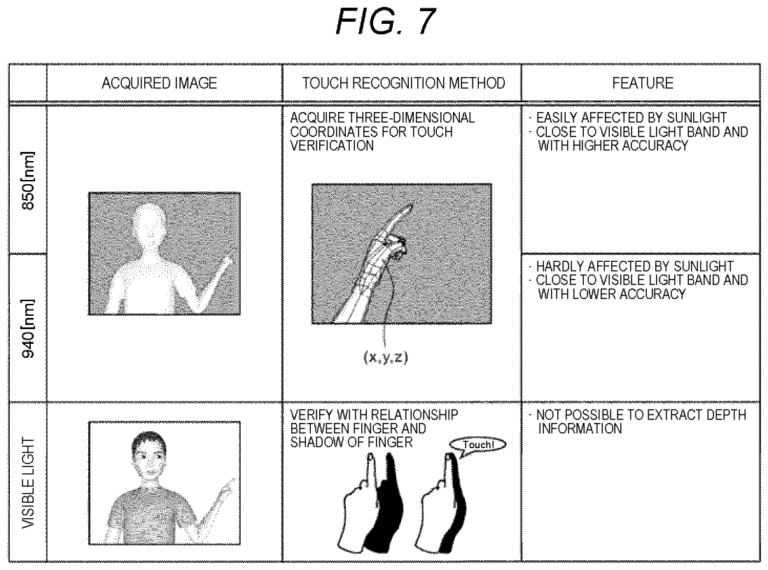

Here, for each type of sensing method, the spatial information obtained by sensing, the operation recognition method in a case where the operation method is the touch operation (the operation recognition method corresponding to the touch operation), and features will be described with reference to FIG. 7. Note that the operation recognition method corresponding to the touch operation will be referred to as a touch recognition method.

In FIG. 7, each of “850 nm”, “940 nm”, and “visible light” in the leftmost column represents the type of the filter 71 of the imaging device 53 and represents the type of sensing method. The row of “850 nm” represents a case of the sensing method in which the filter 71 is the 850 nm filter 71A (a case where the filter 71 is the 850 nm filter 71A). The row of “940 nm” represents a case of the sensing method in which the filter 71 is the 940 nm filter 71B (a case where the filter 71 is the 940 nm filter 71B). The row of “visible light” represents a case of the sensing method in which the filter 71 is the visible light filter 71C (a case where the filter 71 is the visible light filter 71C).

In each row of “850 nm”, “940 nm”, and “visible light”, an image that is the spatial information acquired by the imaging device 53 is exemplified in the field corresponding to “acquired image” that is an item in the uppermost row. Referring to this, in a case where the filter 71 is the 850 nm filter 71A or the 940 nm filter 71B that is an infrared light filter, the depth image (range image) as exemplified commonly in the field corresponding to the “acquired image” is acquired. In a case where the filter 71 is the visible light filter 71C, the color image (the black-and-white image in the drawing) that is a captured image as exemplified in the field corresponding to “acquired image” is acquired.

In each row of “850 nm”, “940 nm”, and “visible light”, an example of the touch recognition method is illustrated in the field corresponding to “touch recognition method” that is an item in the uppermost row. Referring to this, in a case where the filter 71 is the 850 nm filter 71A or the 940 nm filter 71B that is an infrared light filter, three-dimensional coordinates of the hand of the user are calculated on the basis of the depth image (acquired image) as commonly illustrated in the field corresponding to the “touch recognition method”. As a result, touch verification (recognition of the touch operation) as to whether or not a touch operation has been performed on the display 14 (the position of a surface of the display 14) is performed on the basis of the three-dimensional coordinates of the hand of the user. In a case where the filter 71 is the visible light filter 71C, the finger of the user and the shadow of this finger are recognized from the color image (acquired image) as illustrated in the field corresponding to “touch recognition method”. As a result, the touch verification is performed on the basis of the positional relationship between the finger of the user and the shadow of this finger. For example, when the positions of the finger of the user and the shadow of this finger coincide with each other, or when the distance therebetween is a predetermined distance or less, it is recognized that the touch operation has been performed.

In each row of “850 nm”, “940 nm”, and “visible light”, main features of each sensing method are exemplified in the field corresponding to “feature” indicated in the item in the uppermost row. Referring to this, in a case where the filter 71 is the 850 nm filter 71A, as a first feature, depth information (range information) can be obtained from the depth image, but is easily affected by sunlight (light of the sun). As a second feature, the sensing accuracy (range accuracy) is high because the wavelength band is close to the wavelength band of visible light, but the sensing accuracy is decreased under sunlight. In a case where the filter 71 is the 940 nm filter 71B, as a first feature, depth information (range information) can be obtained from the depth image and is hardly affected by sunlight. As a second feature, the sensing accuracy (range accuracy) is low because the wavelength band is far from the wavelength band of visible light, but the sensing accuracy is hardly decreased even under sunlight. In a case where the filter 71 is the visible light filter 71C, there is a feature that depth information (range information) is not directly obtained.

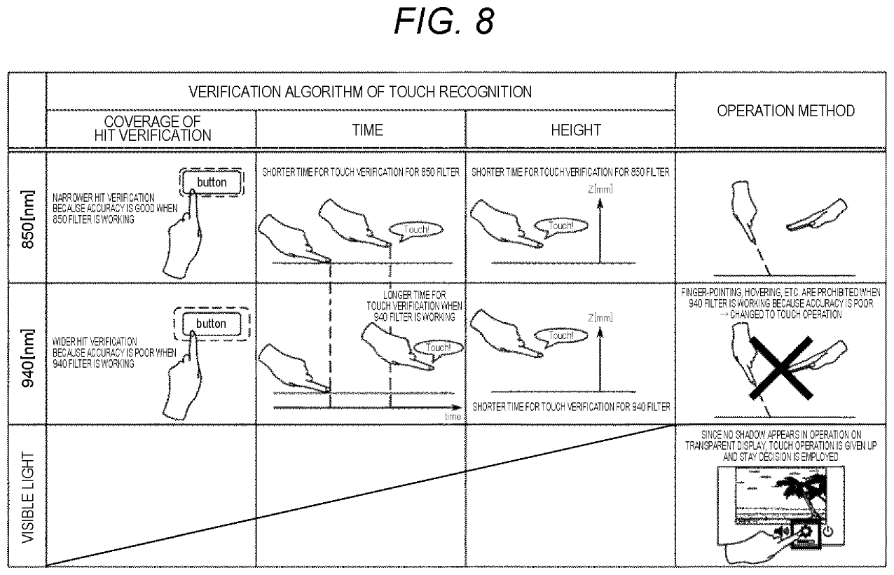

FIG. 8 is a diagram explaining the types of applicable operation methods, and the operation recognition methods in a case where the operation method is the touch operation (the operation recognition methods corresponding to the touch operation) for each type of sensing method.

In FIG. 8, each of “850 nm”, “940 nm”, and “visible light” in the leftmost column represents the type of the filter 71 of the imaging device 53 and represents the type of sensing method. The row of “850 nm” represents a case of the sensing method in which the filter 71 is the 850 nm filter 71A (a case where the filter 71 is the 850 nm filter 71A). The row of “940 nm” represents a case of the sensing method in which the filter 71 is the 940 nm filter 71B (a case where the filter 71 is the 940 nm filter 71B). The row of “visible light” represents a case of the sensing method in which the filter 71 is the visible light filter 71C (a case where the filter 71 is the visible light filter 71C).

In each row of “850 nm”, “940 nm”, and “visible light”, conditions for touch verification in the touch recognition method are illustrated in the field corresponding to “verification algorithm of touch recognition” that is an item in the uppermost row. The conditions for touch verification are conditions under which it is verified (recognized) that a touch operation has been performed.

Here, in the touch verification, for example, the following three conditions are required to be satisfied. As the first condition for touch verification, it is required that the finger of the user be present in a direction perpendicular to the surface of the display 14 with respect to a predetermined hit verification region of the display 14. In a case where a region desired to be touched, such as a button image (button icon), is displayed on the display 14, the hit verification region is a region in which that region desired to be touched (button image) is regarded to have been touched. As the second condition for touch verification, it is required that the distance (height) of the finger of the user to the hit verification region be equal to or less than a predetermined threshold value. As the third condition for touch verification, it is required that time (duration) during which the first condition is satisfied be equal to or more than a predetermined threshold value. In a case where all of these first to third conditions for touch verification are satisfied, it is verified that a touch operation has been performed.

In FIG. 8, “verification algorithm of touch recognition” that is an item in the uppermost row is divided into “coverage of hit verification”, “time”, and “height” that are subitems. In each row of “850 nm” and “940 nm”, the first condition, the third condition, and the second condition for touch verification are illustrated in the fields corresponding to “coverage of hit verification”, “time”, and “height”, respectively. Note that, in a case where the filter 71 is the visible light filter 71C, the touch verification is made on the basis of the positional relationship between the finger and the shadow of the finger as described with reference to FIG. 7. In the present embodiment, since the display 14 is a transparent display, there is no shadow of the finger. Therefore, since the touch verification is infeasible to perform in a case where the filter 71 is the visible light filter 71C, the touch recognition method is excluded from the applicable types of operation recognition methods, and the touch operation is excluded from the applicable types of operation methods. Accordingly, in the row of “visible light” in FIG. 8, the field corresponding to “verification algorithm of touch recognition” is indicated by a blank.

According to FIG. 8, the sizes (coverages) of the hit verification regions in the first condition for touch verification are compared between the case where the filter 71 is the 850 nm filter 71A and the case where the filter 71 is the 940 nm filter 71B. As illustrated in the fields corresponding to “coverage of hit verification”, in both of the former case and the latter case, the hit verification region is set as a region including the button image and larger than the button image with respect to the button image that is a region desired to be touched. However, the hit verification region is set narrower in the former case because the sensing accuracy is higher, and the hit verification region is set wider in the latter case because the sensing accuracy is lower.

The lengths of the durations in the third condition for touch verification are compared between the case where the filter 71 is the 850 nm filter 71A and the case where the filter 71 is the 940 nm filter 71B. As illustrated in the fields corresponding to “time”, the duration is shorter in the former case because the sensing accuracy is higher, and the duration is longer in the latter case because the sensing accuracy is lower.

the heights in the second condition for touch verification are compared between the case where the filter 71 is the 850 nm filter 71A and the case where the filter 71 is the 940 nm filter 71B. As illustrated in the fields corresponding to “height”, the height is lower in the former case because the sensing accuracy is higher, and the height is higher in the latter case because the sensing accuracy is lower.

In this manner, the touch recognition method applicable as the operation recognition method is different between the case where the filter 71 is the 850 nm filter 71A and the case where the filter 71 is the 940 nm filter 71B. The coverages, distances (heights), and durations for the hit verification in the first to third conditions for touch verification vary in correspondence with the difference in sensing accuracy between these cases, whereby erroneous recognition on the touch operation is reduced.

In FIG. 8, in each row of “850 nm”, “940 nm”, and “visible light”, the field corresponding to “operation method” that is an item in the uppermost row indicates an applicable or inapplicable type of operation method. Referring to this, in a case where the filter 71 is the 850 nm filter 71A, since the sensing accuracy is higher, any of the gesture operation (exemplified by the finger-pointing operation) and the hover operation other than the touch operation is applicable as the operation method of the user operation. Accordingly, as the operation recognition method, an operation recognition method corresponding to any operation method of the touch operation, the gesture operation, and the hover operation is applicable.

In a case where the filter 71 is the 940 nm filter 71B, since the sensing accuracy is lower, the application of the gesture operation and the hover operation is prohibited, and only the touch operation is applicable as the operation method of the user operation. Accordingly, only the operation recognition method corresponding to the touch operation is applicable as the operation recognition method.

In a case where the filter 71 is the visible light filter 71C, the application of the touch operation is prohibited, and a stay operation is applicable as the operation method of the user operation. In the stay operation, the user holds a finger at a designated position on the display 14 and keeps the finger still, whereby measurement of stay time is started. When the measurement of the stay time is started, the length of the stay time is presented to the user by a meter displayed on the display 14 or by alteration in the form of a predetermined display image. When the stay time is equal to or more than a preassigned threshold value, it is determined that the operation is to designate the position at which the user holds the finger. In a case where the filter 71 is the visible light filter 71C, only the operation recognition method corresponding to such a stay operation is applicable as the operation recognition method. Note that, in a case where the display 14 is an opaque display, the touch verification can be performed from the positional relationship between the finger of the user and the shadow of the finger. Accordingly, the touch operation may be applicable as the operation method, and the touch recognition operations as illustrated in FIG. 7 may be applicable as the operation recognition method.

### Processing Procedure of Optimization of Sensing Method in First Embodiment

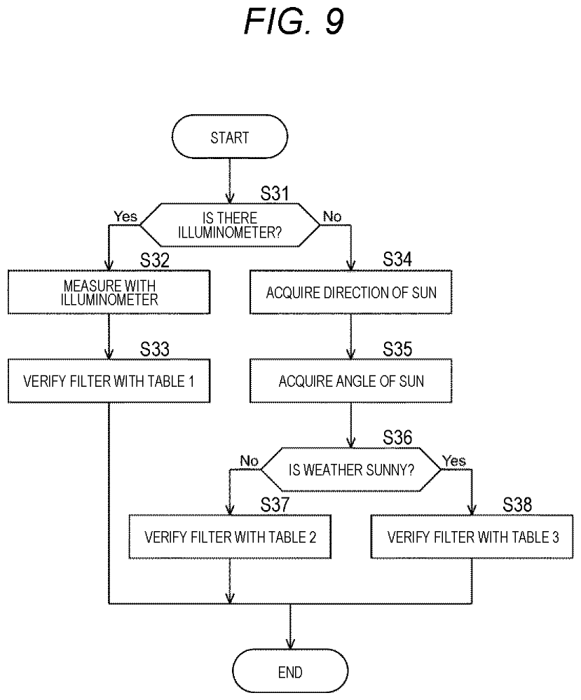

FIG. 9 is a flowchart exemplifying a processing procedure of optimization of the sensing method performed by the information processing system 31 of the first embodiment. In step S31, the optimization processing unit 83 verifies whether or not the host vehicle has an illuminometer for measuring the illuminance of the operating environment. In a case of affirmation in step S31, the processing proceeds to step S32. In step S32, the optimization processing unit 83 causes the illuminometer to measure the illuminance and acquires the measured illuminance. The processing proceeds from step S32 to step S33.

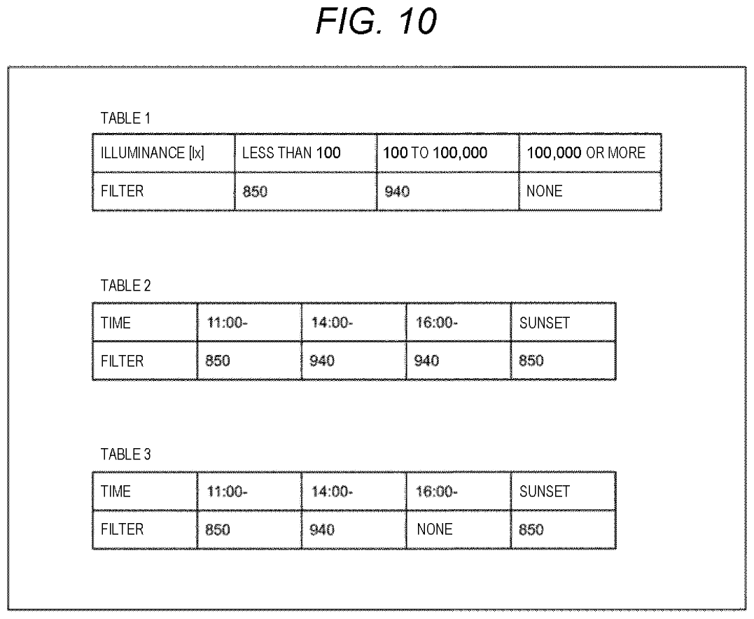

In step S33, the optimization processing unit 83 refers to the tables in FIG. 10 stored in the sensing change rule definition unit 93 of the storage unit 55 as data of the optimization rule and verifies the optimal type of filter to be applied as the filter 71 of the imaging device 53 on the basis of the illuminance acquired in step S32 (optimization of the sensing method). When the processing in step S33 ends, the processing of this flowchart ends.

FIG. 10 is a diagram exemplifying tables that are data of the optimization rules referred to in the flowchart in FIG. 9. In step S33, the optimization processing unit 83 refers to the table of Table 1 in FIG. 10. Referring to this, if the illuminance is less than 100 (1x), it is understood that the operating environment is dark and the influence of the infrared light contained in the sunlight is small, and thus it is determined that the 850 nm filter 71A is to be applied as the filter 71. If the illuminance is 100 (1x) or more and less than 100,100 (1x), it is understood that the influence of infrared light contained in the sunlight is large, and thus it is determined that the 940 nm filter 71B is to be applied as the filter 71. If the illuminance is 100,100 (1x) or more, it is understood that the operating environment is bright and the influence of infrared light contained in the sunlight is too large, and thus it is determined that the visible light filter 71C is to be applied as the filter 71.

In a case of negation in step S31, the processing proceeds to step S34. In step S34, the optimization processing unit 83 acquires (calculates) the direction of the sun with respect to the host vehicle on the basis of the current location of the host vehicle and the current time (date and time) in the environmental information. The processing proceeds from step S34 to step S35. In step S35, the optimization processing unit 83 acquires (calculates) the angle of the sun with respect to the operation space on the basis of the direction of the sun with respect to the host vehicle and the position of the operation space (or the display 14) in the host vehicle. The processing proceeds from step S35 to step S36. In step S36, the optimization processing unit 83 verifies whether or not the weather is sunny on the basis of the meteorology in the environmental information.

In a case of negation in step S36, the processing proceeds to step S37. In step S37, the optimization processing unit 83 refers to the table of Table 2 in FIG. 10. Referring to this, if the time is on or after 11:00 and before 14:00, it is understood that the sunlight hardly comes into the vehicle cabin 11 and the influence of infrared light contained in the sunlight is small, and thus it is determined that the 850 nm filter 71A is to be applied as the filter 71. If the time is on or after 14:00 and before 16:00, it is understood that the sunlight has begun to come into the vehicle cabin 11 and the influence of infrared light contained in the sunlight becomes larger, and thus it is determined that the 940 nm filter 71B is to be applied as the filter 71. If the time is on or after 16:00 and a time before sunset, since the position of the sun is lower, the sunlight easily comes into the vehicle cabin 11. However, considering that the weather is not sunny but cloudy, rainy, or the like, it is understood that the influence of infrared light contained in the sunlight does not alter from the infrared light on or before 16:00, and thus it is determined that the 940 nm filter 71B is to be applied as the filter 71. If it is a time after sunset and before 11:00 in the morning, it is understood that there is almost no influence of infrared light contained in the sunlight, and thus it is determined that the 850 nm filter 71A is to be applied as the filter 71. When the optimization processing unit 83 has verified the optimal type of filter to be applied as the filter 71 in step S37, the processing of this flowchart ends.

In a case of affirmation in step S36, the processing proceeds to step S38. Note that, in a case where the sunlight does not come into the operation space as a result of acquiring (calculating) the angle of the sun with respect to the operation space in step S35, negation may be chosen in step S36 even in a case where the weather is sunny.

In step S38, the optimization processing unit 83 refers to the table of Table 3 in FIG. 10. Referring to this, if the time is on or after 11:00 and before 14:00, it is understood that the sunlight hardly comes into the vehicle cabin 11 and the influence of infrared light contained in the sunlight is small, and thus it is determined that the 850 nm filter 71A is to be arranged as the filter 71. If the time is on or after 14:00 and before 16:00, it is understood that the sunlight has begun to come into the vehicle cabin 11 and the influence of infrared light contained in the sunlight becomes larger, and thus it is determined that the 940 nm filter 71B is to be applied as the filter 71. If the time is on or after 16:00 and a time before sunset, the position of the sun is lower, and thus it is understood that the influence of infrared light contained in the sunlight is large and the sunlight easily comes into the vehicle cabin 11 in consideration of the fact that the weather is sunny. Therefore, it is determined that the visible light filter 71C is to be applied as the filter 71. If it is a time after sunset and before 11:00, it is understood that there is almost no influence of infrared light contained in the sunlight, and thus it is determined that the 850 nm filter 71A is to be applied as the filter 71. When the optimization processing unit 83 has verified the optimal type of filter as the filter 71 in step S38, the processing of this flowchart ends.

According to the optimization of the sensing method based on the flowchart in FIG. 9, a disadvantage that the sensing accuracy for the spatial information decreases, arising from a fluctuation in the amount of infrared light from the outside world to the operation space, is suppressed. This suppresses erroneous recognition or the like of the user operation, and thus the user can comfortably perform the operation regardless of the operating environment.

### <Optimization of Sensing Method Predicting Environmental Fluctuation>

As another example of optimization of the sensing method, a sensing method in which an environmental fluctuation is predicted will be described. The optimization processing unit 83 may predict the operating environment (a fluctuation in the operating environment) from the current time to the time when predetermined predicted time T [S] has elapsed, on the basis of car navigation information, and optimize the sensing method at the current time on the basis of a result of the prediction. In this case, the predicted time T is determined as follows according to the type of content to be displayed on the display 14.

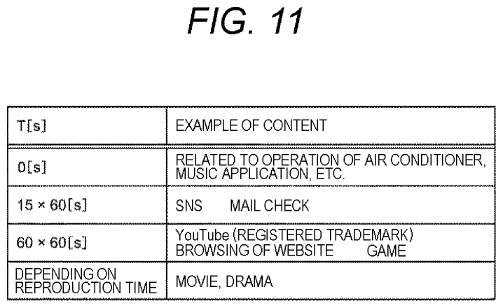

FIG. 11 is a diagram representing relationships between types of content displayed on the display 14 and the predicted time. FIG. 11 illustrates, in the order of the first to fourth rows, examples of content in each of a case where the predicted time T is 0 seconds, a case where the predicted time T is 15 minutes (15×60 seconds), a case where the predicted time T is 60 minutes (60×60 seconds), and a case where the predicted time T depends on the reproduction time. The case where the predicted time T is 0 seconds means that the sensing method is optimized on the basis of only the operating environment (environmental information) at the current time without predicting the operating environment. According to FIG. 11, content related to operation of an air conditioner, a music application, and the like corresponds to the content in the case where the predicted time T is 0 seconds. Content such as a social network system (SNS) or mail check corresponds to the content in the case where the predicted time T is 15 minutes. Content such as a moving image sharing site such as YouTube (registered trademark), browsing a website, or a game corresponds to the content in the case where the predicted time T is 60 minutes. Content in which the reproduction time is fixed, such as a movie or a drama, corresponds to the content in the case where the predicted time T depends on the reproduction time.

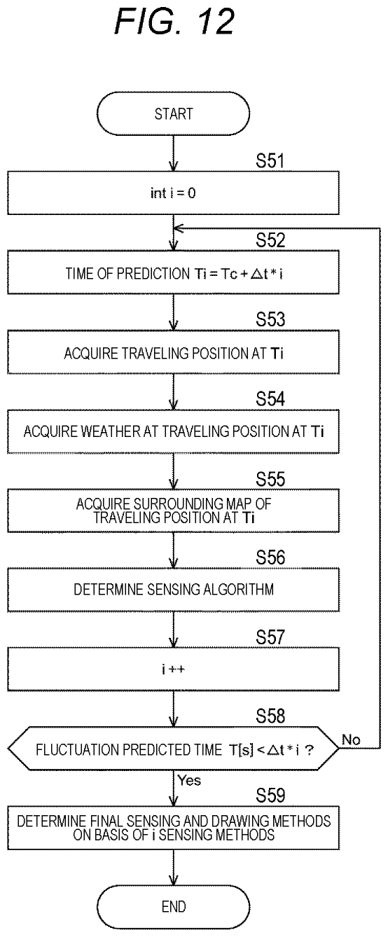

FIG. 12 is a flowchart exemplifying a processing procedure of optimization of the sensing method based on prediction of the operating environment. In step S51, the optimization processing unit 83 sets an integer type variable i to zero. The processing proceeds from step S51 to step S52. In step S52, the optimization processing unit 83 adds Δt×i to a current time Tc to calculate an i-th time of prediction Ti (=Tc+Δt×i). Preassigned time is denoted by Δt, which is time at least shorter than the predicted time T. The processing proceeds from step S52 to step S53.

In step S53, the optimization processing unit 83 acquires a traveling position and a traveling direction at the time of prediction Ti. The traveling position and the traveling direction at the time of prediction Ti can be obtained using information on the moving route to the destination obtained by the navigation information 51. The processing proceeds from step S53 to step S54. In step S54, the optimization processing unit 83 acquires the meteorological information (weather) at the traveling position at the time of prediction Ti. The processing proceeds from step S54 to step S55.

In step S55, the optimization processing unit 83 acquires the surrounding map of the traveling position at the time of prediction Ti. The surrounding map can be acquired from the navigation information 51. The processing proceeds from step S55 to step S56. In step S56, the optimization processing unit 83 determines (predicts) the sensing method and operation recognition method optimal for the operating environment at the time of prediction Ti on the basis of the traveling position (place), the traveling direction, the weather, and the surrounding map, which are the environmental information at the time of prediction Ti acquired in steps S53 to S55. Here, the processing of determining the sensing method and operation recognition method optimal for the operating environment at the time of prediction Ti is performed similarly to the case described in the flowchart in FIG. 9, for example. For example, the sensing method is determined by optimizing the sensing method in accordance with the optimization rule, and the operation recognition method is determined on the basis of any request. However, the processing is not limited to this. Note that an algorithm made up of an algorithm of processing of sensing the spatial information and an algorithm of processing of recognizing the user operation will be referred to as a sensing algorithm as described earlier. The sensing algorithm will also be used as a term representing a combination of the sensing method and the operation recognition method. Referring to this, in step S56, the optimization processing unit 83 determines (predicts) the sensing algorithm optimal for the operating environment at the time of prediction Ti. The processing proceeds from step S56 to step S57.

In step S57, the optimization processing unit 83 increments the variable i. The processing proceeds from step S57 to step S58. In step S58, the optimization processing unit 83 verifies whether or not the predicted time T is shorter than the time Δt×i. In a case of negation in step S58, the processing returns to step S52, and the processing in steps S52 to S58 is repeated. In a case of affirmation in step S58, the processing proceeds to step S59.

In step S59, the optimization processing unit 83 determines the final sensing algorithm to be applied at the current time and the drawing method corresponding to the final sensing algorithm on the basis of the i sensing algorithms predicted (determined) in step S56. When the processing in step S59 ends, the processing of this flowchart ends.

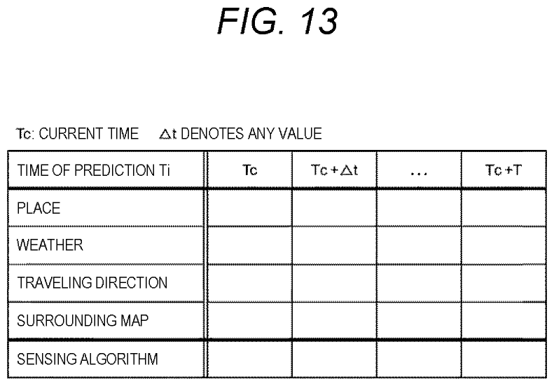

FIG. 13 is a diagram exemplifying information acquired or determined (predicted) in the processing procedure of optimization of the sensing method based on prediction of the operating environment. In FIG. 13, the time of prediction Ti (=Tc+Δt×i, i=0, 1, 2, . . . ) that increases by the time Δt at a time from the current time Tc to the final time of prediction Tc+T is illustrated in the row direction. Information at each time of prediction Ti acquired or predicted in steps S52 to S56 is illustrated in the column direction. Referring to this, at each time of prediction Ti, information on a place where traveling is ongoing at the time of prediction Ti, the weather at the place at the time of prediction Ti, the traveling direction at the time of prediction Ti, and the surrounding map of the place at the time of prediction Ti is acquired as the environmental information. The sensing algorithm optimal for the operating environment at each time of prediction Ti is predicted on the basis of these pieces of environmental information at each time of prediction Ti. On the basis of a result of such prediction, in step S59, the optimal sensing algorithm to be applied at the current time Tc is determined.

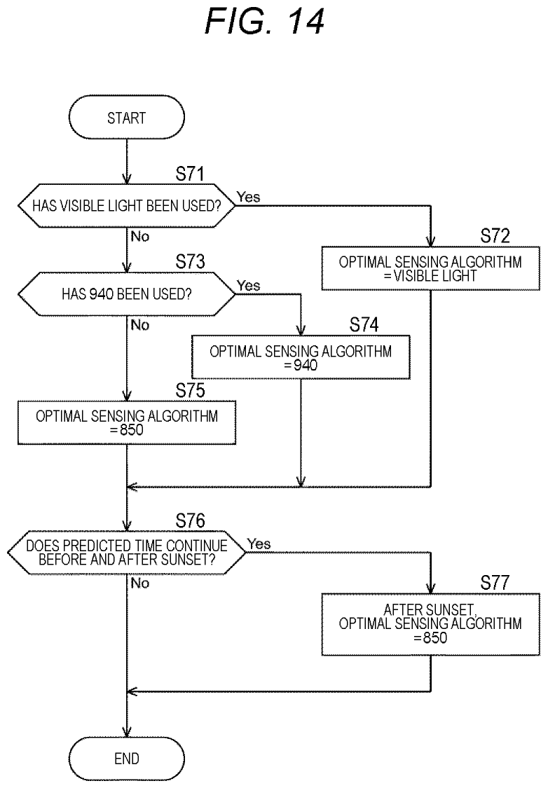

FIG. 14 is a flowchart exemplifying a final processing procedure in optimization of the sensing method based on prediction of the operating environment. In step S71, the optimization processing unit 83 verifies whether or not there is a sensing algorithm in which the filter 71 is the visible light filter 71C even once, among the optimal sensing algorithms predicted at each time of prediction Ti (i=0, 1, 2, . . . ). In a case of affirmation in step S71, the processing proceeds to step S72. In step S72, the optimization processing unit 83 determines the optimal sensing algorithm to be applied at the current time Tc as the sensing algorithm in which the filter 71 is the visible light filter 71C. The processing proceeds from step S72 to step S76.

In a case of negation in step S71, the processing proceeds to step S73. In step S73, the optimization processing unit 83 verifies whether or not there is a sensing algorithm in which the filter 71 is the 940 nm filter 71B even once, among the optimal sensing algorithms predicted at each time of prediction Ti (i=0, 1, 2, . . . ). In a case of affirmation in step S73, the processing proceeds to step S74. In step S74, the optimization processing unit 83 determines the optimal sensing algorithm to be applied at the current time Tc as the sensing algorithm in which the filter 71 is the 940 nm filter 71B. The processing proceeds from step S74 to step S76. In a case of negation in step S73, the processing proceeds to step S75. In step S75, the optimization processing unit 83 determines the optimal sensing algorithm to be applied at the current time Tc as a sensing algorithm in which the filter 71 is the 850 nm filter 71A. The processing proceeds from step S75 to step S76.

In step S76, the optimization processing unit 83 verifies whether or not the predicted time T continues before and after sunset. That is, it is verified whether or not the time of sunset is sandwiched between the current time Tc and the time when the predicted time T has elapsed from the current time Tc. In a case of affirmation in step S76, the processing proceeds to step S77. In step S77, the optimization processing unit 83 will change, after sunset, the optimal sensing algorithm to a sensing algorithm in which the 850 nm filter 71A is applied as the filter 71. This realizes improvement of the sensing accuracy. After the processing in step S77 ends, the processing of this flowchart ends. In a case of negation in step S76, the processing of this flowchart ends.

According to the optimization of the sensing method based on prediction of the operating environment described above with reference to FIGS. 11 to 14, since the optimal sensing algorithm at the current time Tc is determined by supposing a case where the operating environment is most exposed to sunlight in a period until the predicted time T has elapsed, the situation in which the operation is disabled is prevented in advance at least while the predicted time T elapses.

### <Notification to User at Time of Changing Operation Method>

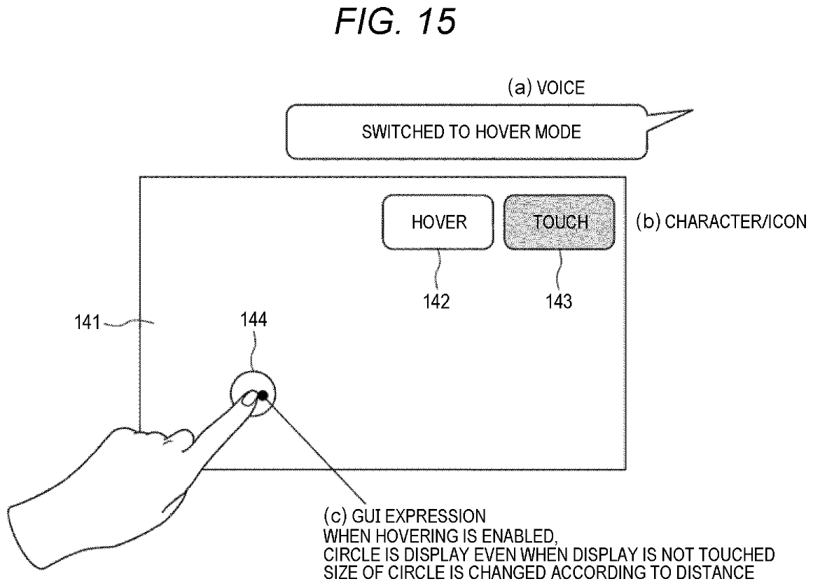

FIG. 15 is a diagram explaining an example of a notification at the time of changing the operation method. In FIG. 15, respective portions represented by (a) voice, (b) character/icon, and (c) GUI expression represent three forms of notifying the user that the operation method has been changed in line with the change in the sensing algorithm. In (a) voice, the form is for notifying the user by voice that the operation method has been changed. In this case, for example, when the operation method has been changed to the hover operation, a voice such as “switched to the hover mode” is output from a speaker (not illustrated) or the like. In (b) character/icon, the form is for displaying that the operation method has been changed, by an image such as a character or an icon in an output image 141 displayed on the display 14. In this case, for example, in the output image 141, an icon 142 representing the hover operation and an icon 143 representing the touch operation are drawn as icons representing the types of operation methods. The icons 142 and 143 have different drawing forms (color, brightness, and the like) between a case where the operation method is valid and a case where the operation method is invalid. The drawing form of the icon alters in a case where the operation method has been changed, whereby the user is notified of the change in the operation method. Alternatively, the user may be notified of the change in the operation method by a drawing form such as blinking of an icon corresponding to the operation method switched to a valid option from an invalid option. The fact that the operation method has been changed may be displayed by characters instead of icons. In (c) GUI expression, the form is for notifying the user by GUI that the operation method has been changed. In this case, for example, a circle is drawn in a region designated by the user with the touch operation or hover operation in the output image 141. In a case where the hover operation is enabled, a circle is displayed even when the user is not touching the display 14, and the size of the circle is changed according to the distance between the finger of the user and the display 14.

According to such notification at the time of changing the operation method, an unexpected situation in which the user can no longer perform the operation without noticing that the operation method has been changed can be prevented in advance.

### Information Processing System of Second Embodiment

In an information processing system according to the second embodiment, attention is focused on the fact that there are other people (whether or not there are other people) around the operation space (user) (around the outside of the host vehicle), as an environmental factor among diverse environmental factors that have influence on (bring about a fluctuation in) the operating environment. Arising from this, there is a possibility that a finger-pointing operation or the like may give discomfort to other people. In order to suppress such a disadvantage, the operation method is preferentially optimized.

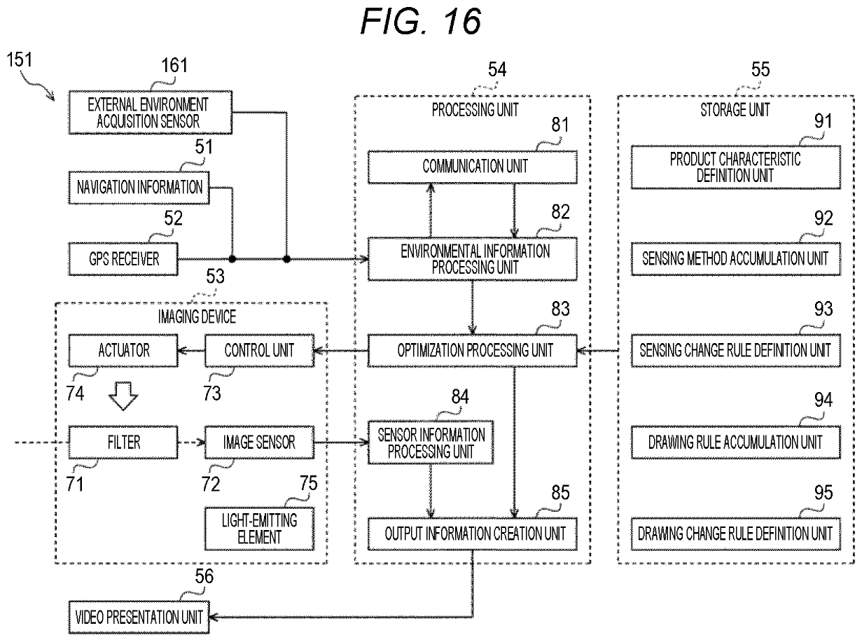

FIG. 16 is a block diagram illustrating a configuration example of the information processing system according to the second embodiment. Note that, in the drawing, portions corresponding to those of the information processing system 31 in FIG. 2 are given the same reference signs, and detailed description thereof will be appropriately omitted.

An information processing system 151 of the second embodiment in FIG. 16 includes navigation information 51, a GPS receiver 52, an imaging device 53, a processing unit 54, a storage unit 55, a video presentation unit 56, and an external environment acquisition sensor 161. Accordingly, the information processing system 151 in FIG. 16 is common to the information processing system 31 in FIG. 2 in including the navigation information 51, the GPS receiver 52, the imaging device 53, the processing unit 54, the storage unit 55, and the video presentation unit 56. However, the information processing system 151 in FIG. 16 is different from the information processing system 31 in FIG. 2 in newly including the external environment acquisition sensor 161.

The external environment acquisition sensor 161 is a sensor that acquires information on an environment around the outside of the host vehicle as a part of the operating environment. Specifically, the external environment acquisition sensor 161 is a camera (imaging device) that is directed to the outside of the host vehicle to capture the outside around the host vehicle. External environmental information (captured image) acquired by the external environment acquisition sensor 161 is supplied to an environmental information processing unit 82.

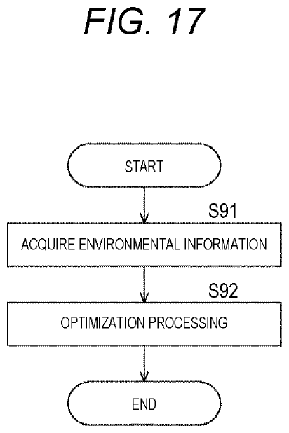

FIG. 17 is a flowchart exemplifying a schematic procedure of processing performed by the information processing system 151 of the second embodiment. In step S91, the environmental information processing unit 82 acquires the environmental information. The environmental information includes the GPS information from the GPS receiver 52, the meteorological information from the external server device via the communication unit 81, and the external environmental information from the external environment acquisition sensor 161. The processing proceeds from step S91 to step S92.

In step S92, an optimization processing unit 83 optimizes the operation method on the basis of the environmental information acquired in step S91 and the optimization rule (the optimization rule indicated by the data of a sensing change rule definition unit 93). The optimization processing unit 83 determines the sensing method, the operation recognition method, and the drawing method on the basis of any request (also including a request according to the optimization rule).

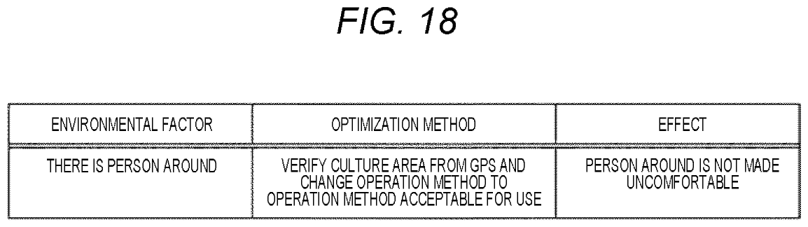

FIG. 18 is a diagram explaining an optimization rule when the information processing system 151 of the second embodiment optimizes the operation method. FIG. 18 illustrates a focused environmental factor, an optimization method that is an optimization rule when the operation method is optimized on the basis of the environmental factor, and an effect by the optimization of the operation method. Referring to this, attention is focused on the fact that there is a person (whether or not there is a person) around the outside of the host vehicle, which is around the operation space, as an environmental factor. In the optimization of the operation method, in a case where there is a person around the outside of the host vehicle, the optimization processing unit 83 verifies a culture area to which the current location belongs, from the GPS information, and changes (determines) the operation method according to the culture area. The effects in this case include that a person around the outside of the host vehicle is not made uncomfortable.

For example, in a case where no person is present on a farther side (back surface side) of a display 14, the optimization processing unit 83 assumes that the touch operation, the gesture operation, or the hover operation is to be applied as the operation method. In one case, the operation method in the case where no person is present on the back surface side of the display 14 may be determined in a similar manner to the information processing system 31 of the first embodiment that does not consider whether or not a person is present on the back surface side of the display 14. In this case, the decision operation and the selection operation are performed, for example, by performing the touch operation, the gesture operation, or the hover operation on a predetermined position on the output image displayed on the display 14 with a forefinger or the like. In a case where the display 14 is a transparent display such as a window glass, when a person is present on the back surface side of the display 14, there is a possibility that a user operation with a forefinger or the like may give discomfort to the person on the back surface side of the display 14. Such a situation is not desirable also for the user. Therefore, the optimization processing unit 83 changes the operation method between a case where a person is present on the back surface side of the display 14 and a case where no person is present. The optimization processing unit 83 also changes the drawing method in line with the change in the operation method. As for the decision operation, for example, in a case where a person is present on the back surface side of the display 14, the optimization processing unit 83 applies the gesture operation as the operation method and adopts a proper gesture according to the culture area as the decision operation.

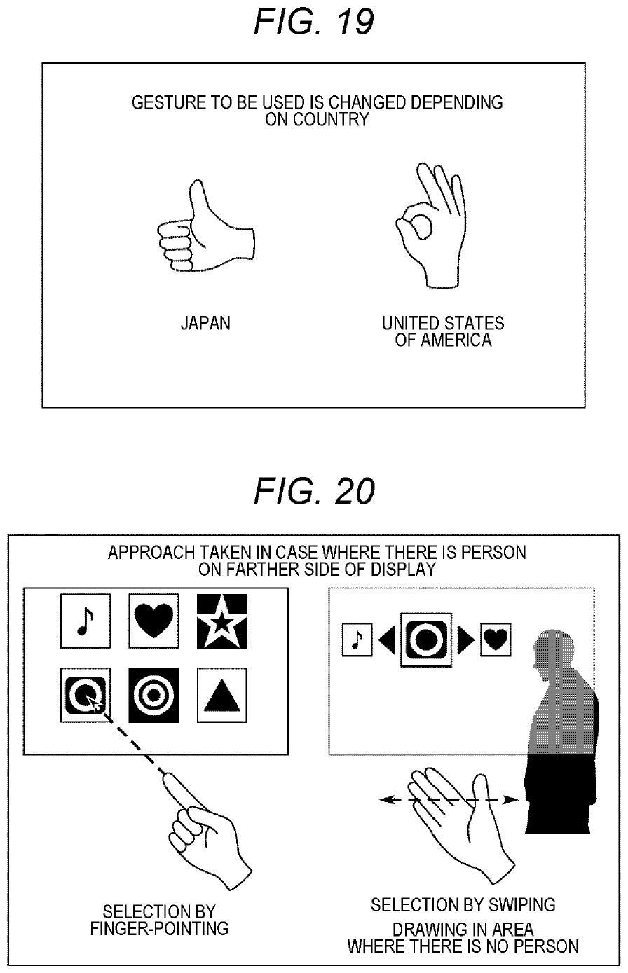

FIG. 19 is a diagram explaining operation methods relating to the decision operation in the information processing system 151 of the second embodiment. FIG. 19 exemplifies decision operations in Japan and the United States of America. Referring to this, in a case where a person is present on the back surface side of the display 14, the optimization processing unit 83 adopts a thumbs-up gesture operation as illustrated on the left side of FIG. 19, as the decision operation, if the current location of the host vehicle is Japan. If the current location of the host vehicle is the United States of America, an OK sign gesture operation illustrated on the right side of FIG. 19 is adopted as the decision operation.

As for the selection operation, for example, in a case where a person is present on the back surface side of the display 14, the optimization processing unit 83 applies the touch operation, the gesture operation, or the hover operation as the operation method and adopts swiping as the selection operation. Note that, in the present embodiment, since the operation method of the decision operation is the gesture operation, the operation method of the selection operation is also assumed to be the gesture operation.

FIG. 20 is a diagram explaining operation methods relating to the selection operation in the information processing system 151 of the second embodiment. FIG. 20 exemplifies selection operations in a case where a person is present on the back surface side of the display 14 and in a case where no person is present. Referring to this, in a case where no person is present on the back surface side of the display 14, the optimization processing unit 83 adopts the finger-pointing operation of the gesture operation indicating the selection position on the display 14, as the selection operation, for example, as illustrated on the left side of FIG. 20. Note that, as the drawing method for the output image for performing the selection operation, a drawing method of drawing a list of selectable menu icons is applied.

In a case where a person is present on the back surface side of the display 14, the optimization processing unit 83 adopts swiping of the gesture operation, as the selection operation, for example, as illustrated on the right side of FIG. 20. In a case where the swiping is adopted as the selection operation, the optimization processing unit 83 applies a drawing method of drawing a selection image for the swipe operation, as the drawing method for the output information creation unit 85. In the selection image for the swipe operation, for example, a plurality of selectable menu icons is scrolled and drawn at a preassigned selection position by swiping. In this case, the menu icon stopped at the selection position is assumed as the selected menu icon. In addition, the optimization processing unit 83 may apply, as the drawing method for the output information creation unit 85, a drawing method adapted to draw the selection image for the swipe operation at a position not overlapping with a person on the back surface side of the display 14.

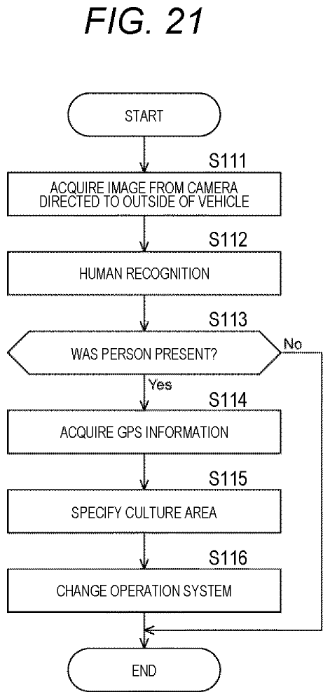

FIG. 21 is a flowchart exemplifying a processing procedure of optimization of the operation method performed by the information processing system 151 of the second embodiment. In step S111, the optimization processing unit 83 acquires an image obtained by capturing the outside around the host vehicle as the external environmental information from a camera of the external environment acquisition sensor 161. The processing proceeds from step S111 to step S112. In step S112, the optimization processing unit 83 performs human recognition processing of detecting (recognizing) an image of a person from among the images acquired in step S111. The processing proceeds from step S112 to step S113. In step S113, the optimization processing unit 83 verifies whether or not a person was present on the back surface side of the display 14 on the basis of a result of the human recognition processing in step S112. Note that the optimization processing unit 83 may verify whether or not a person is present in a range not limited to the back surface side of the display 14, for example, around the outside of the host vehicle.

In a case of negation in step S113, the processing of this flowchart ends. In a case of affirmation in step S113, the processing proceeds to step S114. In step S114, the optimization processing unit 83 acquires the GPS information from the GPS receiver 52. The processing proceeds from step S114 to step S115. In step S115, the optimization processing unit 83 specifies a culture area to which the current location of the host vehicle belongs, on the basis of the GPS information acquired in step S114. The processing proceeds from step S115 to step S116.

In step S116, the optimization processing unit 83 optimizes the operation method on the basis of the culture area specified in step 115 and the optimization rule (the optimization rule indicated by the data of the sensing change rule definition unit 93 of the storage unit 55). That is, the optimization processing unit 83 determines an operation method that has proper decision operation and selection operation for the specified culture area, as the optimal operation method. When the operation method has been optimized, the optimization processing unit 83 determines the optimal sensing method and operation recognition method (optimal sensing algorithm) within applicable types with respect to the optimized operation method. In line with the change in the operation method, the optimization processing unit 83 changes the drawing method for the output image on the basis of the optimization rule (the optimization rule indicated by the data of the drawing change rule definition unit 95 of the storage unit 55). When the processing in step S116 ends, the processing of this flowchart ends.

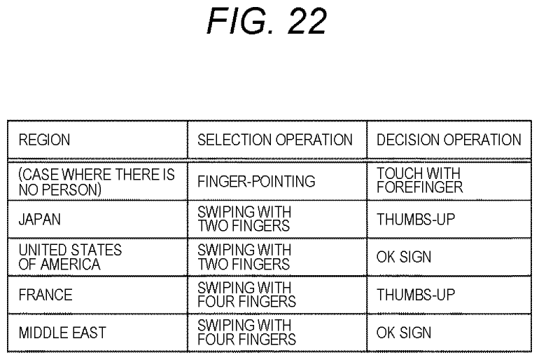

FIG. 22 is a diagram exemplifying data regarding optimization rules used for optimization of the operation method by the information processing system 151 of the second embodiment. According to FIG. 22, in a case where no person is present on the back surface side of the display 14, the optimization processing unit 83 will apply, as the optimal operation method, an operation method in which the selection operation is performed by the finger-pointing operation and the decision operation is performed by the touch operation with the forefinger or the like.

In a case where a person is present on the back surface side of the display 14, the optimization processing unit 83 applies, as the optimal operation method, an operation method that has a selection operation and a decision operation corresponding to a culture area (region) to which the current location of the host vehicle belongs. For example, in a case where the current position of the vehicle is Japan, the optimization processing unit 83 applies, as the optimal operation method, a gesture operation in which the selection operation is performed by swiping with two fingers and the decision operation is performed by thumbs-up. In a case where the current location of the host vehicle is the United States of America, the optimization processing unit 83 applies, as the optimal operation method, a gesture operation in which the selection operation is performed by swiping with two fingers and the decision operation is performed by the OK sign. In a case where the current location of the host vehicle is the Republic of France, the optimization processing unit 83 applies, as the optimal operation method, a gesture operation in which the selection operation is performed by swiping with four fingers and the decision operation is performed by thumbs-up. In a case where the current location of the host vehicle is the Middle East region, the optimization processing unit 83 applies, as the optimal operation method, a gesture operation in which the selection operation is performed by swiping with four fingers and the decision operation is performed by the OK sign.

According to the information processing system 151 of the second embodiment, a disadvantage that the user operation such as the finger-pointing operation gives discomfort to other people, arising from the fact that there is a person around the operation space (around the host vehicle), can be suppressed. This allows the user to comfortably perform the operation without worrying about the presence of other people.

### Information Processing System of Third Embodiment

The third embodiment of the information processing system focuses on the fact that the air temperature is low (the air temperature fluctuates) in the operating environment, as an environmental factor among diverse environmental factors that have influence on (bring about a fluctuation in) the operating environment. Arising from this, there is a possibility that the user may feel uncomfortable, for example, the hand of the user may cool (the user is uncomfortable). In order to suppress such a disadvantage, the operation method is preferentially optimized.

Since an information processing system as the third embodiment has the same configuration as the configuration of the information processing system 151 in FIG. 16, the description of the configuration will be omitted, and the information processing system of the third embodiment will be described using the same reference signs as the reference signs of the information processing system 151 in FIG. 16.

In an information processing system 151 of the third embodiment, an external environment acquisition sensor 161 is a sensor that acquires an air temperature (temperature) around the outside of the host vehicle. The air temperature acquired by the external environment acquisition sensor 161 is supplied to an environmental information processing unit 82 as external environmental information. Note that, in one case, the external environment acquisition sensor 161 may acquire the air temperature inside the host vehicle, the temperature of the window glass serving as a display 14, or the like, instead of the air temperature around the outside of the host vehicle.

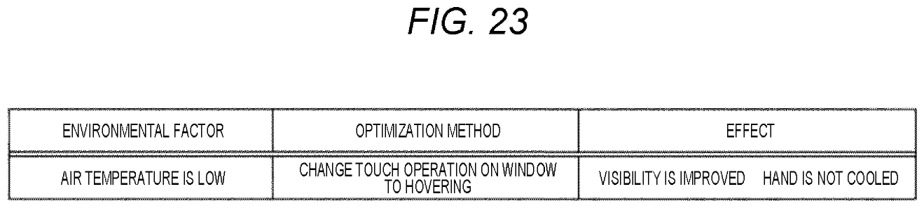

FIG. 23 is a diagram explaining an optimization rule when the information processing system 151 of the third embodiment optimizes the operation method so as to achieve a user operation optimal for the operating environment. FIG. 23 illustrates a focused environmental factor, an optimization method that is an optimization rule when the operation method is optimized on the basis of the environmental factor, and an effect by the optimization of the operation method. Referring to this, attention is focused on the fact that the air temperature is low (equal to or lower than a predetermined temperature T degrees), as an environmental factor. In the optimization of the operation method, an optimization processing unit 83 applies the hover operation as the operation method in consideration of the environmental factor that the air temperature is low for the operating environment. When the touch operation is applied as the operation method in a case where the air temperature is not low (higher than the temperature T degrees), the operation method is changed to the hover operation from the touch operation as the air temperature becomes lower. The effects in this case include that the visibility is improved and the hand is not cooled.

For example, when the air temperature lowers, the window glass becomes cold, and in a case where the window glass serves as the display 14, a touch operation of touching the display 14 becomes troublesome. In addition, there is a case where the window glass serving as the display 14 has dew condensation, and there is a possibility that the visibility of the output image may deteriorate when the touch operation is performed because fogging is partially removed. Therefore, when the air temperature is low, the hover operation that does not touch the display 14 is applied as the operation method. Note that, in a case where the air temperature is low, the gesture operation may be applied as the operation method. In the present embodiment, the external environment acquisition sensor 161 may detect whether or not dew condensation or dirt has occurred on the screen of the display 14, and in a case where dew condensation or dirt has occurred, the operation method may be changed to the hover operation from the touch operation.

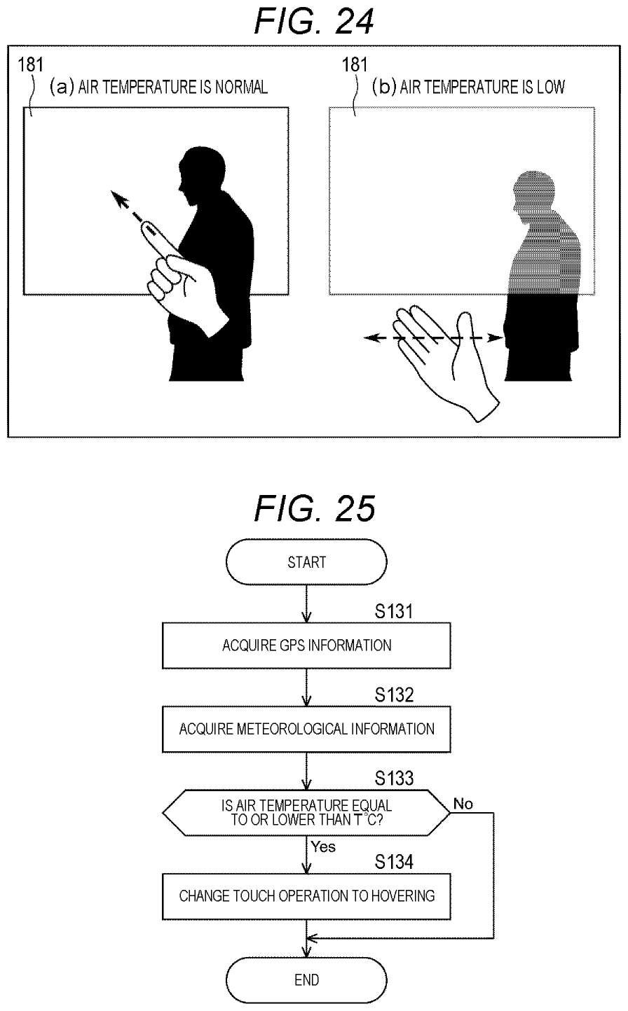

FIG. 24 is a diagram explaining an operation method optimized by the information processing system of the third embodiment. In FIG. 24, the diagram on the left side represents a case where the touch operation is applied as the operation method on an output image 181 displayed on the display 14 in a case where the air temperature is not low (higher than the temperature T degrees). The diagram on the right side represents that the hover operation is applied as the operation method on the output image 181 in a case where the air temperature is low (equal to or lower than the temperature T degrees).

FIG. 25 is a flowchart exemplifying a processing procedure of optimization of the operation method performed by the information processing system 151 of the third embodiment. Note that this flowchart illustrates a case where the external environment acquisition sensor 161 does not include a sensor that acquires the air temperature (temperature) around the outside of the host vehicle. In step S131, the optimization processing unit 83 acquires the GPS information from the environmental information processing unit 82. The processing proceeds from step S131 to step S132. In step S132, the optimization processing unit 83 acquires the meteorological information at the current location of the host vehicle from the environmental information processing unit 82 on the basis of the GPS information acquired in step S131. The processing proceeds from step S132 to step S133.

In step S133, the optimization processing unit 83 verifies whether or not the air temperature at the current location is equal to or lower than the predetermined temperature T degrees on the basis of the meteorological information acquired in step S132. Note that, in a case where the external environment acquisition sensor 161 includes a sensor that acquires the air temperature (temperature) around the outside of the host vehicle, the optimization processing unit 83 may verify whether or not the air temperature at the current location is equal to or lower than the predetermined temperature T degrees on the basis of the air temperature acquired from the external environment acquisition sensor 161. In a case of negation in step S133, the processing of this flowchart ends. In a case of affirmation in step S133, the processing proceeds to step S134. In step S134, the optimization processing unit 83 changes the operation method to the hover operation from the touch operation. When the processing in step S134 ends, the processing of this flowchart ends.

According to the information processing system 151 of the third embodiment, a disadvantage that the visibility of the display 14 decreases due to the touch operation or the hand of the user cools (the user is uncomfortable), arising from a low air temperature in the operating environment, can be suppressed. This allows the user to comfortably perform the operation regardless of the operating environment.

### Information Processing System of Fourth Embodiment

In an information processing system of the fourth embodiment, attention is focused on the fact that the sunlight comes (whether or not the sunlight comes) into the operation space, as an environmental factor among diverse environmental factors that have influence on (bring about a fluctuation in) the operating environment. Arising from this, there is a possibility that the user may get sunburned, or there is a possibility that the user may feel hot and uncomfortable. In order to suppress such a disadvantage, the operation method is preferentially optimized.

Since the information processing system of the fourth embodiment has the same configuration as the configuration of the information processing system 31 in FIG. 1, the description of the configuration will be omitted, and the information processing system of the fourth embodiment will be described using the same reference signs as the reference signs of the information processing system 31 in FIG. 2.

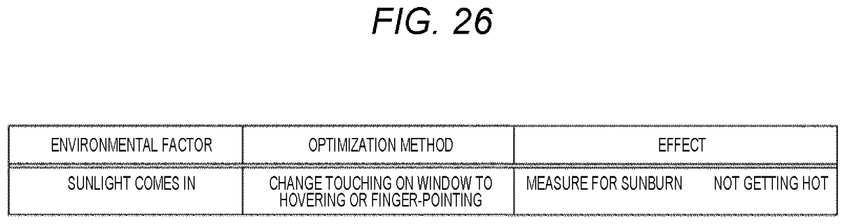

FIG. 26 is a diagram explaining an optimization rule when an information processing system 31 of the fourth embodiment optimizes the operation method so as to achieve a user operation optimal for the operating environment. FIG. 26 illustrates a focused environmental factor, an optimization method that is an optimization rule when the operation method is optimized on the basis of the environmental factor, and an effect by the optimization of the operation method. Referring to this, attention is focused on the fact that the sunlight is coming through the display 14 that is a window glass, as an environmental factor. In the optimization of the operation method, an optimization processing unit 83 applies the gesture operation (finger-pointing operation) or the hover operation as the operation method in consideration of the environmental factor that the sunlight is coming into the operating environment. When the touch operation is applied as the operation method in a case where the sunlight is not coming in, the operation method of the user operation is changed to the gesture operation or the hover operation from the touch operation as the sunlight comes in. The effects in this case include that a measure is taken for sunburn and the hand of the user does not get hot.

For example, in a case where the window glass serves as the display 14, there is a possibility that, with the touch operation, the sunlight may shine on the arm or hand, and sunburn or high heat may occur when the sunlight is coming in through the window glass. Therefore, in a case where the sunlight comes in, the gesture operation or the hover operation in which the operation can be performed in a region away from the display 14 and not exposed to sunlight is applied as the operation method such that the arm or hand of the user is not exposed to the sunlight.

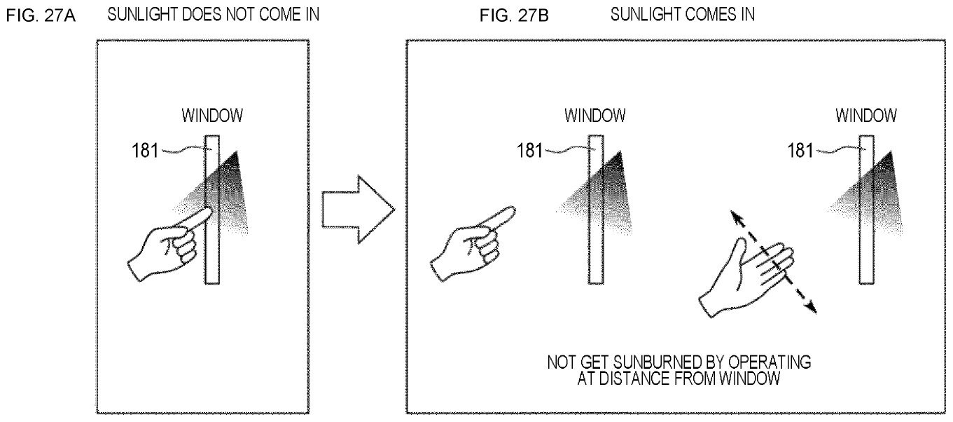

FIG. 27 is a diagram explaining an operation method optimized by the information processing system 31 of the fourth embodiment. According to FIG. 27, as in (a) of FIG. 27, it is assumed that the touch operation is applied as the operation method on an output image 181 on the display 14 in a case where the sunlight does not come in. In contrast to this, in a case where the sunlight comes in, as in (b) of FIG. 27, the operation method of the user operation on the output image 181 on the display 14 is changed to, for example, the gesture operation (finger-pointing operation) or the hover operation.

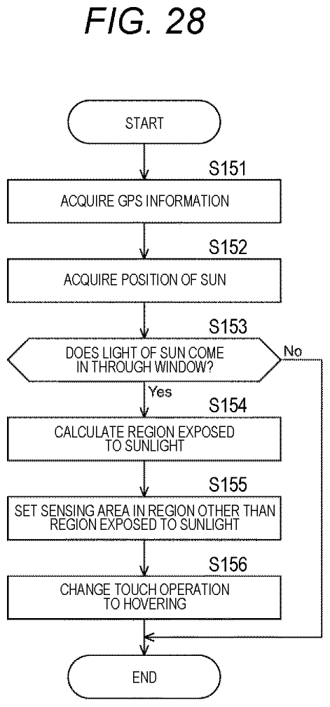

FIG. 28 is a flowchart exemplifying a processing procedure of optimization of the operation method performed by the information processing system 31 of the fourth embodiment. In step S151, the optimization processing unit 83 acquires the GPS information from an environmental information processing unit 82. The processing proceeds from step S151 to step S152. In step S152, the optimization processing unit 83 acquires the position of the sun on the basis of the GPS information acquired in step S151. The processing proceeds from step S152 to step S153. In step S153, the optimization processing unit 83 verifies whether or not the sunlight comes in through the window glass (display 14) on the basis of the position of the sun acquired in step S152. In a case of negation in step S153, the processing of this flowchart ends.

In a case of affirmation in step S153, the processing proceeds to step S154. In step S154, the optimization processing unit 83 calculates a region exposed to the light of the sun. The processing proceeds from step S154 to step S155. In step S155, the optimization processing unit 83 sets a region other than the region exposed to the sunlight, as a sensing area. The sensing area represents a region where the user operation is effectively detected. The processing proceeds from step S155 to step S156. Note that, by setting a region not exposed to the sunlight as a sensing area, the user can perform the operation in a region not exposed to the sunlight.

In step S156, the optimization processing unit 83 changes the operation method to the hover operation (or the gesture operation) from the touch operation. When the processing in step S156 ends, the processing of this flowchart ends.

According to the information processing system 31 of the fourth embodiment, a disadvantage that the user gets sunburned or the user gets hot, arising from the sunlight coming into the operation space, can be suppressed. This allows the user to comfortably perform the operation regardless of the operating environment.

### Information Processing System of Fifth Embodiment

In an information processing system of the fifth embodiment, attention is focused on the amount of infrared light (a fluctuation in the amount of light) from the outside world to the operation space, as an environmental factor among diverse environmental factors that have influence on (bring about a fluctuation in) the operating environment. Arising from this, there is a possibility that the sensing accuracy for the spatial information may decrease. In order to suppress such a disadvantage, the sensing method is preferentially optimized. The information processing system of the fifth embodiment is common to the information processing system of the first embodiment in that the amount of infrared light (a fluctuation in the amount of light) from the outside world to the operation space is focused as an environmental factor and the sensing method is preferentially optimized. However, the information processing system of the fifth embodiment is different from the first embodiment in terms of an object to be considered when recognizing the amount of infrared light (a fluctuation in the amount of light) included in the outside world.

Since the information processing system of the fifth embodiment has the same configuration as the configuration of the information processing system 151 in FIG. 16, the description of the configuration will be omitted, and the information processing system of the fifth embodiment will be described using the same reference signs as the reference signs of the information processing system 151 in FIG. 16.

In an information processing system 151 of the fifth embodiment, an external environment acquisition sensor 161 is, for example, a power meter that measures power (amount of light) of infrared light (near-infrared light) outside the host vehicle. The amount of infrared light acquired by the external environment acquisition sensor 161 is supplied to an environmental information processing unit 82 as external environmental information.

However, a case where the information processing system 151 of the fifth embodiment does not include a power meter as the external environment acquisition sensor 161 is also supposed. In the information processing system 31 of the first embodiment, in a case where the weather at the current location of the vehicle is sunny, the type of the filter 71 is specified using the table of Table 3 in FIG. 10. At this time, in a case where the current location is a place hardly exposed to the sunlight, such as in a multistory parking lot, a tunnel, or a forest, infrared light hardly has influence, and an 850 nm filter 71A can be applied as the filter 71. An optimization processing unit 83 can verify whether or not the current location is a place hardly exposed to the sunlight by collating the GPS information with map information. This can enhance the sensing accuracy. Meanwhile, even in a tunnel, illumination light containing infrared light from a halogen lamp or the like is sometimes used in the case of an old tunnel. In that case, similarly to the case where the weather is sunny, it is desirable to specify the type of the filter 71 using the table of Table 3 in FIG. 10. Note that, in cases where illumination light containing infrared light is used, the type of the filter 71 may be specified in accordance with a table (rule) other than the table of Table 3 in FIG. 10 in one case.

In contrast to this, in a case where, for example, the information processing system 151 includes a power meter as the external environment acquisition sensor 161, the presence or absence of infrared light can be directly detected irrespective of what place the current location is. In a case where no infrared light is detected (in a case where the amount (power) of infrared light is equal to or less than a predetermined threshold value), the 850 nm filter 71A can be applied as the filter 71. This can enhance the sensing accuracy. In a case where infrared light has been detected (in a case where the amount of infrared light is larger than the predetermined threshold value), it is desirable to specify the type of the filter 71 using the table of Table 3 in FIG. 10, similarly to the case where the weather is sunny. Note that, in cases where infrared light has been detected, the type of the filter 71 may be specified in accordance with a table (rule) other than the table of Table 3 in FIG. 10 in one case.

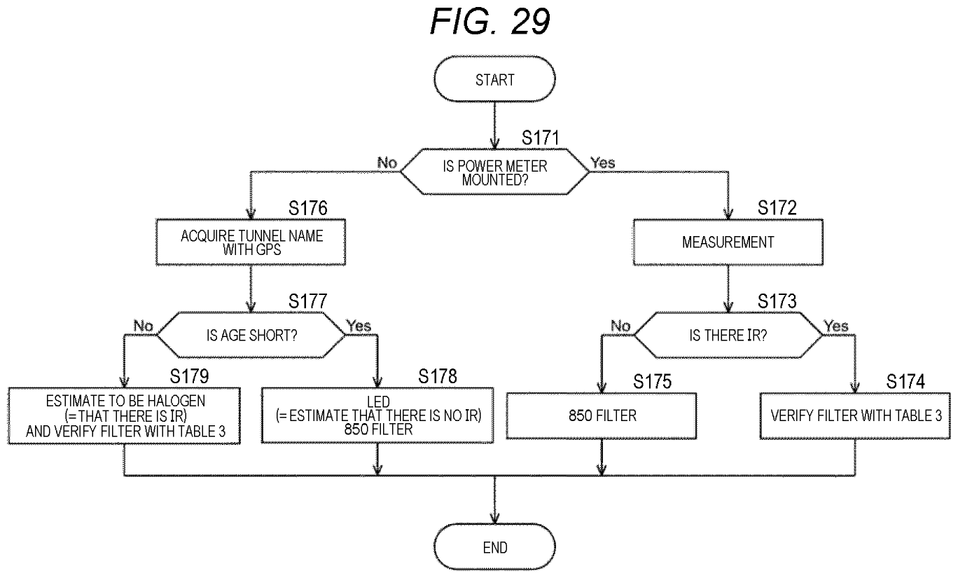

FIG. 29 is a flowchart exemplifying a processing procedure of optimization of the sensing method performed by the information processing system 151 of the fifth embodiment. In step S171, the optimization processing unit 83 verifies whether or not a power meter that measures the amount (power) of infrared light outside the host vehicle is included as the external environment acquisition sensor 161. In a case of affirmation in step S171, the processing proceeds to step S172.

In step S172, the amount of infrared light is measured with the external environment acquisition sensor 161, and the optimization processing unit 83 acquires a result of the measurement. The processing proceeds from step S172 to step S173. In step S173, the optimization processing unit 83 verifies whether or not infrared light has been detected (whether or not the amount of infrared light is larger than a predetermined threshold value).

In a case of affirmation in step S173, the processing proceeds to step S174. In step S174, the optimization processing unit 83 verifies (determines) the type of the filter 71 using the table of Table 3 in FIG. 10. When the processing in step 174 ends, the processing of this flowchart ends. In a case of negation in step S173, the processing proceeds to step S175. In step S175, the optimization processing unit 83 determines to apply the 850 nm filter as the filter 71. When the processing in step 175 ends, the processing of this flowchart ends.

In a case of negation in step S171, the processing proceeds to step S176. In step S176, the optimization processing unit 83 acquires the navigation information 51 (map information) and the GPS information and acquires the tunnel name in a case where the current location is in the tunnel. The processing proceeds from step S176 to step S177. Note that the process for a case where the current location is not in the tunnel will be omitted.

In step S177, the optimization processing unit 83 acquires the age of the tunnel and verifies whether or not the age of the tunnel is short (whether or not the age of the tunnel is equal to or less than a predetermined threshold value). In one case, the age of the tunnel may be acquired from the Internet via the communication unit 81. In a case of affirmation in step S177, the processing proceeds to step S178. In step S178, the optimization processing unit 83 verifies that a light-emitting diode (LED) is used as the illumination lamp and determines to apply the 850 nm filter 71A as the filter 71. When the processing in step 178 ends, the processing of this flowchart ends.

In a case of negation in step S177, the processing proceeds to step S179. In step S179, the optimization processing unit 83 verifies that a halogen lamp is used as the illumination lamp and verifies (determines) the type of the filter 71 using the table of Table 3 in FIG. 10. When the processing in step 179 ends, the processing of this flowchart ends.

According to the information processing system 151 of the fifth embodiment, a disadvantage that the sensing accuracy for the spatial information decreases, arising from a fluctuation in the amount of infrared light from the outside world to the operation space, is suppressed. This suppresses erroneous recognition or the like of the user operation, and thus the user can comfortably perform the operation regardless of the operating environment.

### Another Configuration Example of Imaging Device 53

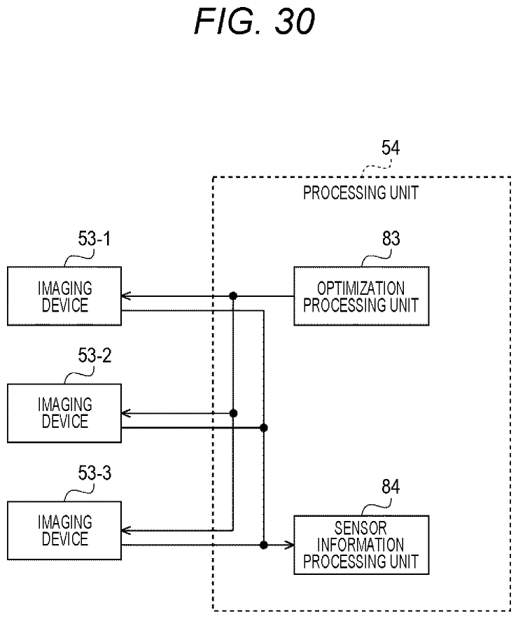

FIG. 30 depicts blocks illustrating another configuration example of the imaging device 53 in FIG. 2 (or FIG. 16). In FIG. 30, portions corresponding to those in FIG. 2 (or FIG. 16) are given the same reference signs, and detailed description thereof will be omitted.

In FIG. 30, imaging devices 53-1, 53-2, and 53-3 are provided instead of the imaging device 53 in FIG. 2. The imaging device 53-1 is an imaging device that performs sensing equivalent to a case where the 850 nm filter 71A is arranged as the filter 71 in the imaging optical system in the imaging device 53 in FIG. 2. The imaging device 53-2 is an imaging device that performs sensing equivalent to a case where the 940 nm filter 71B is arranged as the filter 71 in the imaging optical system in the imaging device 53 in FIG. 2. The imaging device 53-3 is an imaging device that performs sensing equivalent to a case where the visible light filter 71C is arranged as the filter 71 in the imaging optical system in the imaging device 53 in FIG. 2. Note that the imaging devices 53-1, 53-2, and 53-3 are different from the imaging device 53 in that a mechanism for switching between the types of filters arranged in the imaging optical system is not included, and the imaging device 53-3 is different from the imaging device 53 in that the light-emitting element 75 that emits infrared light is not included.

Each of the imaging devices 53-1, 53-2, and 53-3 is controlled as to whether or not sensing is to be performed, by the optimization processing unit 83 of the processing unit 54. The spatial information obtained by sensing by the imaging devices 53-1, 53-2, and 53-3 is supplied to the sensor information processing unit 84 of the processing unit 54.

Referring to this, by switching the imaging device caused to perform sensing among the imaging devices 53-1, 53-2, and 53-3, the optimization processing unit 83 in FIG. 30 can switch the sensing method similarly to the case of switching the type of the filter 71 of the imaging device 53 in FIG. 2. That is, instead of changing the sensing method by switching the filter in one imaging device, the sensing method can be switched by switching the imaging device to be effectively used among a plurality of imaging devices having different types of filters.

### <Program>

A series of processing tasks of the processing unit 54 in the information processing systems 31 and 151 described above can be executed by hardware or can also be executed by software. In a case where the series of processing tasks is executed by the software, a program forming that software is installed on a computer. Here, examples of the computer include a computer incorporated in dedicated hardware, and a general-purpose personal computer or the like capable of executing various functions by installing various programs, for example.

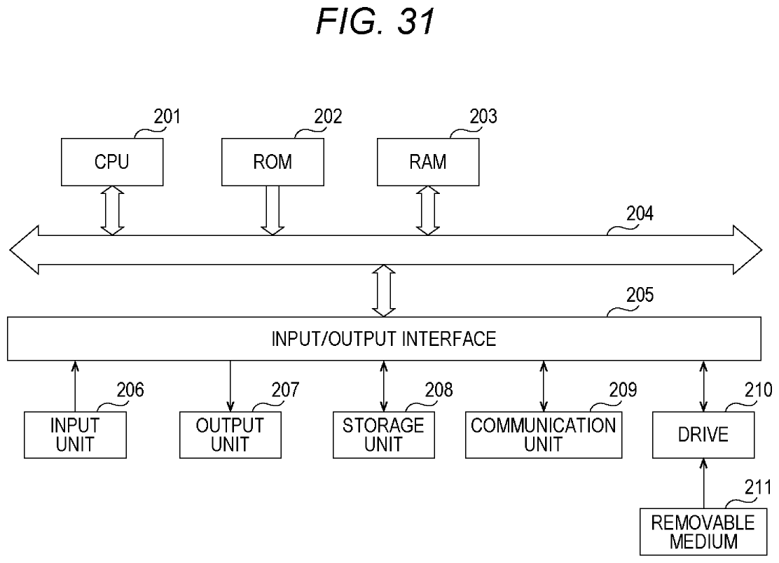

FIG. 31 is a block diagram illustrating a configuration example of hardware of a computer in a case where the computer executes each processing task executed by the processing unit 54 in the information processing systems 31 and 151 with a program. In the computer, a central processing unit (CPU) 201, a read only memory (ROM) 202, and a random access memory (RAM) 203 are interconnected by a bus 204.

An input/output interface 205 is further connected to the bus 204. An input unit 206, an output unit 207, a storage unit 208, a communication unit 209, and a drive 210 are connected to the input/output interface 205.

The input unit 206 includes a keyboard, a mouse, a microphone, and the like. The output unit 207 includes a display, a speaker, and the like. The storage unit 208 includes a hard disk, a nonvolatile memory, and the like. The communication unit 209 includes a network interface and the like. The drive 210 drives a removable medium 211 such as a magnetic disk, an optical disc, a magneto-optical disk, or a semiconductor memory.

In the computer configured as described above, for example, the CPU 201 loads the program stored in the storage unit 208 into the RAM 203 via the input/output interface 205 and the bus 204 and executes the program, thereby performing the above-described series of processing tasks.

The program executed by the computer (CPU 201) can be provided by being recorded on the removable medium 211 as a package medium or the like, for example. In addition, the program can be provided via a wired or wireless transmission medium such as a local area network, the Internet, or digital satellite broadcasting.

In the computer, the program can be installed in the storage unit 208 via the input/output interface 205 by attaching the removable medium 211 to the drive 210. In addition, the program can be received by the communication unit 209 via a wired or wireless transmission medium and installed in the storage unit 208. Besides, the program can be preinstalled in the ROM 202 or the storage unit 208.

Note that, the program executed by the computer may be a program that performs processing in a time-series manner in the order described in the present description, or may be a program that performs processing in parallel or at a necessary timing such as when a call is made.

The present technology can also take the following configurations.

(1)

An information processing device
including:
an environmental information acquisition unit that acquires environmental information for recognizing an environment of an operation space in which a user performs an operation on an image displayed in a vehicle cabin;
an operation recognition unit that performs recognition of the operation of the user on the basis of first spatial information on the operation space sensed using first light or second spatial information on the operation space sensed using second light having a wavelength band different from a wavelength band of the first light; and
a determination unit that determines spatial information to be used for the recognition by the operation recognition unit from among the first spatial information and the second spatial information on the basis of the environmental information acquired by the environmental information acquisition unit.

(2)

The information processing device according to (1) above, in which
the determination unit ensures, by changing a sensing method of a single sensor, that the spatial information to be used for the recognition by the operation recognition unit, among the first spatial information and the second spatial information, is supplied to the operation recognition unit.

(3)

The information processing device according to (1) above, in which
the determination unit ensures that the spatial information to be used for the recognition by the operation recognition unit, among the first spatial information sensed by a first sensor and the second spatial information sensed by a second sensor, is supplied to the operation recognition unit.

(4)

The information processing device according to (1) or (2) above, in which
the operation recognition unit switches between a first recognition method for performing the recognition on the basis of the first spatial information and a second recognition method for performing the recognition on the basis of the second spatial information, according to the spatial information to be used for the recognition.

(5)

The information processing device according to (4) above, in which
in the operation recognition unit, a first operation method of the operation on which the recognition is performed by the first recognition method is different from a second operation method of the operation on which the recognition is performed by the second recognition method.

(6)

The information processing device according to any one of (1) to (5) above, in which
the operation recognition unit changes a recognition method for performing the recognition, according to an operation method of the operation.

(7)

The information processing device according to any one of (1) to (6) above,
further including
an operation method determination unit that determines an operation method of the operation on which the operation recognition unit performs the recognition, on the basis of the environmental information acquired by the environmental information acquisition unit.

(8)

The information processing device according to (7) above, in which
the operation method determination unit acquires information regarding an air temperature, sunlight coming into the operation space, a person, or dew condensation or dirt on a screen to display the image, according to the environmental information, and determines the operation method on the basis of the acquired information.

(9)

The information processing device according to (8) above, in which
the operation method determination unit determines any one of a touch operation, a gesture operation, and a hover operation, as the operation method.

(10)

The information processing device according to any one of (1) to (9) above, in which
the first light and the second light include infrared light and visible light, or infrared light and infrared light.

(11)

The information processing device according to any one of (1) to (10) above, in which
the first spatial information and the second spatial information include a captured image and a depth image, or a depth image and a depth image.

(12)

The information processing device according to any one of (1) to (11) above, in which
the determination unit acquires information regarding meteorological information, illuminance, or an amount of infrared light, according to the environmental information, and determines the spatial information to be used for the recognition by the operation recognition unit, on the basis of the acquired information.

(13)

The information processing device according to any one of (1) to (12) above, in which
the determination unit predicts the environment of the operation space at a plurality of times in a period from a current time to a future time of prediction, on the basis of the environmental information, and determines the spatial information to be used for the recognition at the current time on the basis of a verification result as to which of the first spatial information and the second spatial information is the spatial information desired to be used for the recognition at each of the plurality of times at prediction, on the basis of the environments at the plurality of the times at prediction.

(14)

An information processing system including:
a display unit that displays an image in a vehicle cabin;
an environmental information acquisition unit that acquires environmental information for recognizing an environment of an operation space in which a user performs an operation on the display unit;
an imaging unit that performs sensing of spatial information on the operation space, using first light or second light;
an operation recognition unit that performs recognition of the operation of the user on the basis of the spatial information sensed by the imaging unit; and
a determination unit that determines light to be used for the sensing by the imaging unit from among the first light and the second light on the basis of the environmental information acquired by the environmental information acquisition unit.

(15)

An information processing method including:
by an environmental information acquisition unit of an information processing device including:
the environmental information acquisition unit;
an operation recognition unit; and
a determination unit,
acquiring environmental information for recognizing an environment of an operation space in which a user performs an operation on an image displayed in a vehicle cabin;
by the operation recognition unit, performing recognition of the operation of the user on the basis of first spatial information on the operation space sensed using first light or second spatial information on the operation space sensed using second light having a wavelength band different from a wavelength band of the first light; and
by the determination unit, determining spatial information to be used for the recognition by the operation recognition unit from among the first spatial information and the second spatial information on the basis of the environmental information acquired by the environmental information acquisition unit.

(16)

A program for causing a computer to function as:
an environmental information acquisition unit that acquires environmental information for recognizing an environment of an operation space in which a user performs an operation on an image displayed in a vehicle cabin;
an operation recognition unit that performs recognition of the operation of the user on the basis of first spatial information on the operation space sensed using first light or second spatial information on the operation space sensed using second light having a wavelength band different from a wavelength band of the first light; and
a determination unit that determines spatial information to be used for the recognition by the operation recognition unit from among the first spatial information and the second spatial information on the basis of the environmental information acquired by the environmental information acquisition unit.

### REFERENCE SIGNS LIST

11 Vehicle cabin
13 Video presentation device
14 Display
15 Sensor
31 Information processing system
51 Navigation information
52 GPS receiver
53 Imaging device
54 Processing unit
55 Storage unit
56 Video presentation unit
71 Filter
71A 850 nm filter
71B 940 nm filter
71C Visible light filter
72 Image sensor
73 Control unit
75 Light-emitting element
81 Communication unit
82 Environmental information processing unit
83 Optimization processing unit
84 Sensor information processing unit
85 Output information creation unit
91 Product characteristic definition unit
92 Sensing method accumulation unit
93 Sensing change rule definition unit
94 Drawing rule accumulation unit
95 Drawing change rule definition unit

The invention claimed is:

1. An information processing device comprising:
an environmental information acquisition unit that acquires environmental information for recognizing an environment of an operation space in which a user performs an operation on an image displayed in a vehicle cabin;
an operation recognition unit that performs recognition of the operation of the user on a basis of first spatial information on the operation space sensed using first light or second spatial information on the operation space sensed using second light having a wavelength band different from a wavelength band of the first light; and
a determination unit that determines spatial information to be used for the recognition by the operation recognition unit from among the first spatial information and the second spatial information on a basis of the environmental information acquired by the environmental information acquisition unit.

2. The information processing device according to claim 1, wherein
the determination unit ensures, by changing a sensing method of a single sensor, that the spatial information to be used for the recognition by the operation recognition unit, among the first spatial information and the second spatial information, is supplied to the operation recognition unit.

3. The information processing device according to claim 1, wherein
the determination unit ensures that the spatial information to be used for the recognition by the operation recognition unit, among the first spatial information sensed by a first sensor and the second spatial information sensed by a second sensor, is supplied to the operation recognition unit.

4. The information processing device according to claim 1, wherein
the operation recognition unit switches between a first recognition method for performing the recognition on a basis of the first spatial information and a second recognition method for performing the recognition on a basis of the second spatial information, according to the spatial information to be used for the recognition.

5. The information processing device according to claim 4, wherein
in the operation recognition unit, a first operation method of the operation on which the recognition is performed by the first recognition method is different from a second operation method of the operation on which the recognition is performed by the second recognition method.

6. The information processing device according to claim 1, wherein
the operation recognition unit changes a recognition method for performing the recognition, according to an operation method of the operation.

7. The information processing device according to claim 1,
further comprising
an operation method determination unit that determines an operation method of the operation on which the operation recognition unit performs the recognition, on a basis of the environmental information acquired by the environmental information acquisition unit.

8. The information processing device according to claim 7, wherein
the operation method determination unit acquires information regarding an air temperature, sunlight coming into the operation space, a person, or dew condensation or dirt on a screen to display the image, according to the environmental information, and determines the operation method on a basis of the acquired information.

9. The information processing device according to claim 8, wherein
the operation method determination unit determines any one of a touch operation, a gesture operation, and a hover operation, as the operation method.

10. The information processing device according to claim 1, wherein
the first light and the second light include infrared light and visible light, or infrared light and infrared light.

11. The information processing device according to claim 1, wherein
the first spatial information and the second spatial information include a captured image and a depth image, or a depth image and a depth image.

12. The information processing device according to claim 1, wherein
the determination unit acquires information regarding meteorological information, illuminance, or an amount of infrared light, according to the environmental information, and determines the spatial information to be used for the recognition by the operation recognition unit, on a basis of the acquired information.

13. The information processing device according to claim 1, wherein
the determination unit predicts the environment of the operation space at a plurality of times in a period from a current time to a future time of prediction, on a basis of the environmental information, and determines the spatial information to be used for the recognition at the current time on a basis of a verification result as to which of the first spatial information and the second spatial information is the spatial information desired to be used for the recognition at each of the plurality of times at prediction, on a basis of the environments at the plurality of the times at prediction.

14. An information processing system comprising:
a display unit that displays an image in a vehicle cabin;
an environmental information acquisition unit that acquires environmental information for recognizing an environment of an operation space in which a user performs an operation on the display unit;
an imaging unit that performs sensing of spatial information on the operation space, using first light or second light;
an operation recognition unit that performs recognition of the operation of the user on a basis of the spatial information sensed by the imaging unit; and
a determination unit that determines light to be used for the sensing by the imaging unit from among the first light and the second light on a basis of the environmental information acquired by the environmental information acquisition unit.

15. An information processing method comprising:
by an environmental information acquisition unit of an information processing device including:
the environmental information acquisition unit;
an operation recognition unit; and
a determination unit,
acquiring environmental information for recognizing an environment of an operation space in which a user performs an operation on an image displayed in a vehicle cabin;
by the operation recognition unit, performing recognition of the operation of the user on a basis of first spatial information on the operation space sensed using first light or second spatial information on the operation space sensed using second light having a wavelength band different from a wavelength band of the first light; and
by the determination unit, determining spatial information to be used for the recognition by the operation recognition unit from among the first spatial information and the second spatial information on a basis of the environmental information acquired by the environmental information acquisition unit.

16. A program for causing a computer to function as:
an environmental information acquisition unit that acquires environmental information for recognizing an environment of an operation space in which a user performs an operation on an image displayed in a vehicle cabin;
an operation recognition unit that performs recognition of the operation of the user on a basis of first spatial information on the operation space sensed using first light or second spatial information on the operation space sensed using second light having a wavelength band different from a wavelength band of the first light; and
a determination unit that determines spatial information to be used for the recognition by the operation recognition unit from among the first spatial information and the second spatial information on a basis of the environmental information acquired by the environmental information acquisition unit.
